(19) United States
(12) Patent Application Publication
(10) Pub. No.: US 2019/0021154 A1
(43) Pub. Date: Jan. 17, 2019

(54) Solid State Lighting Systems

(71) Applicant: INNOSYS. INC., Salt Lake City,, UT (US)

(72) Inventor: Laurence P. Sadwick, Salt Lake City, UT (US)

(21) Appl. No.: 15/750,483

(22) PCT Filed: Aug. 4, 2016
(86) PCT No.: PCT/US16/45659

§ 371 Date: Feb. 5, 2018

Related U.S. Application Data
(60) Provisional application No. 62/201,109, filed on Aug. 4, 2015.

(51) Int. Cl. H05B 37/02; H05B 33/08; F21V 23/04

(52) U.S. Cl. CPC H05B 37/0245; H05B 33/0809; H02M 1/44; F21V 23/0471; H05B 33/0845

(57) ABSTRACT

A lighting system includes at least one solid state light adapted to replace a lamp in a fluorescent lamp fixture, and a power supply configured to convert power drawn from the fluorescent lamp fixture to power the at least one solid state light. The power supply includes a rectifier, a voltage regulator, a power output for the at least one solid state light, and an auxiliary DC power output. The power supply is configured to generate a regulated DC voltage at the auxiliary DC power output based on the power drawn from the fluorescent lamp fixture.

### BACKGROUND

Fluorescent lamps are widely used in a variety of applications, such as for general purpose lighting in commercial, industrial, office, home and residential locations, etc. Conventional fluorescent tubes used for general lighting cannot, in general, be directly plugged into alternating current (AC) voltage lines. Fluorescent lamps generally include a glass tube, linear, circular, spiral or other shaped bulb containing a gas at low pressure, such as argon, xenon, neon, or krypton, along with low pressure mercury vapor. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies.

Electronic ballasts convert the input AC voltage supplied (typically at a low AC frequency of 50 or 60 Hz) power into generally a sinusoidal AC output waveform typically designed for a constant current output in the frequency range of above 20 to 40 kHz to typically less than 100 kHz and sometimes greater than 100 kHz. Magnetic ballasts limit the typically 50 or 60 Hz current to an appropriate value for the florescent tubes and lamps.

Fluorescent lamps can suffer from a number of disadvantages, such as a relatively short life span, flickering, and noisy ballasts, etc. However nowadays there are many high quality electronic ballasts that are available. Although the ballasts may be of high quality and long life, often the fluorescent tubes that are powered by the ballasts, suffer from a number of undesirable effects including reduced lifetime due, for example, to being switched on and off too often.

### SUMMARY

The present invention provides solid state lighting including a fluorescent replacement that, for example, powers a solid state lighting source such as, for example, but not limited to, a LED and/or OLED and/or QD lamp from a fluorescent fixture, including operating and being powered by electronic ballasts. Embodiments of the present invention also allow for digital lighting and a digital platform in general.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 depicts a solid state lighting power supply that can draw power from a fluorescent lamp fixture in accordance with some embodiments of the invention.

FIG. 2 depicts a ballast control circuit that can be used to control or disable the power supply of FIG. 1 in accordance with some embodiments of the invention.

FIG. 3 depicts an overvoltage or overtemperature control circuit that can be used to control or disable the power supply of FIG. 1 in accordance with some embodiments of the invention.

FIG. 4 depicts an isolated power supply along with a voltage to pulse width converter circuit that can be used to convert a voltage level such as an isolated voltage reference to a pulse width modulated signal based on a dimming control signal in accordance with some embodiments of the invention.

FIG. 5 depicts a power conversion stage circuit in accordance with some embodiments of the invention.

FIG. 6 depicts a power conversion stage circuit in accordance with some embodiments of the invention.

FIGS. 7A-7B depict a voltage to pulse width converter circuits in accordance with some embodiments of the invention.

FIG. 8 depicts a follower dimming circuit that isolates a dimming control signal in accordance with some embodiments of the invention.

FIG. 9 depicts a solid state lighting power supply that can draw power from a fluorescent lamp fixture in accordance with some embodiments of the invention.

FIG. 10 depicts a power conversion stage circuit in accordance with some embodiments of the invention.

FIG. 11 depicts an overcurrent protection circuit in accordance with some embodiments of the invention.

FIG. 12 depicts an undervoltage protection circuit in accordance with some embodiments of the invention.

FIG. 13 depicts a dither circuit in accordance with some embodiments of the invention.

FIG. 14 depicts a block diagram of a solid state lighting system with multiple fluorescent lamp replacements and multiple control devices in accordance with some embodiments of the invention.

FIG. 15 depicts a block diagram of a solid state lighting system which includes a Control/Monitor/Log/Tracking circuit in accordance with some embodiments of the invention.

FIG. 16 depicts a block diagram of a dimmer for a solid state lighting system which can receive and transmit dimming commands through a variety of input sources and output interfaces in accordance with some embodiments of the invention.

FIG. 17 depicts a block diagram of a solid state lighting system with multiple fluorescent lamp replacements, localized sensors and communications to a Gateway in accordance with some embodiments of the invention.

FIG. 18 depicts a block diagram of another solid state lighting system with multiple fluorescent lamp replacements, multiple localized sensors and communications to a Gateway in accordance with some embodiments of the invention.

FIG. 19 depicts a block diagram of another solid state lighting system with multiple fluorescent lamp replacements, multiple localized sensors and communications to a Gateway in accordance with some embodiments of the invention.

FIG. 20 depicts a block diagram of another solid state lighting system with multiple fluorescent lamp replacements, multiple localized sensors and communications to a Gateway in accordance with some embodiments of the invention.

FIG. 21 depicts a block diagram of a solid state lighting system with a smart capable fluorescent lamp replacement, solid state light and control system with a peripheral interface in accordance with some embodiments of the invention.

FIG. 22 depicts a block diagram of a solid state lighting system with multiple smart capable fluorescent lamp replacements and control system with a peripheral interface in accordance with some embodiments of the invention.

FIG. 23 depicts a block diagram of a solid state lighting system with multiple smart capable fluorescent lamp replacements and control system with a peripheral interface and buss connection in accordance with some embodiments of the invention.

FIG. 24 depicts a block diagram of a solid state lighting system with multiple smart capable fluorescent lamp replacements and control system with a peripheral interface, multiple sensors and buss connection in accordance with some embodiments of the invention.

FIG. 25 depicts a block diagram of a solid state lighting system with multiple smart capable fluorescent lamp replacements with signaling transmitters, and a control system with a signaling receiver and peripheral interface, multiple sensors and buss connection in accordance with some embodiments of the invention.

FIG. 26 depicts a block diagram of a solid state lighting system which comprises multiple fluorescent lamp fixtures, including multiple smart capable fluorescent lamp replacements, control systems, multiple remote sensors, buss connection and gateway in accordance with some embodiments of the invention.

FIG. 27 depicts an example wall switch connected to multiple dimmers in accordance with some embodiments of the invention.

FIG. 28 depicts an example inrush current limiter in accordance with some embodiments of the invention.

FIGS. 29-37 depict block diagrams of solid state lighting systems that can be powered by both AC lines and ballast outputs and can be remote controlled and dimmed in both modes.

FIG. 38 depicts a wirelessly controlled solid state lighting system/LED fluorescent lamp replacement with multiple different color temperature lamps is depicted in accordance with some embodiments of the invention.

### DETAILED DESCRIPTION OF THE INVENTION

A fluorescent replacement is disclosed herein that may be used to power one or more LED or other solid state lamps from a fluorescent fixture, whether the fixture includes a ballast of any type or not. Various power supplies that draw power from the fluorescent fixture are disclosed to power one or more solid state lamps. Various dimming control systems are disclosed to receive and process control signals from one or more sources and to control one or more solid state lamps.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention comprise an LED Fluorescent Lamp Replacement that is remote dimmable and can also be Triac, Triac-based, forward and reverse dimmer dimmable and incorporates all of the discussion above for the example embodiments. The remote fluorescent lamp replacement ballast can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc.

In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics.

Some embodiments of the present invention may use multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C, PLC, and others discussed in this document, etc. In various embodiments, the control signals can be received and used by the remote fluorescent lamp replacement ballast or by the LED, OLED and/or QD fluorescent lamp replacement or both.

Such a Remote Controlled Florescent Ballast Replacement can also support color LED Fluorescent Lamp Replacements including single and multi-color including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc.

Color-changing/tuning can include, but is not limited to, white color-tuning including the color temperature tuning/adjustments/settings/etc., color correction temperature (CCT), color rendering index (CRI), etc.

Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. Some embodiments of the present invention can change to different colors when using light sources capable of supporting such (i.e., LEDs, OLEDs and/or QDs including but not limited to red, green, blue, amber, white LEDs and/or any other possible combination of LEDs and colors).

Embodiments of the present invention has the ability to store color choices, selections, etc. and retrieve, restore, display, update, etc. these color choices and selections when using non-fluorescent light sources that can support color changing.

Embodiments of the present invention also have the ability to change between various color choices, selections, and associated inputs to do as well as the ability to modulate the color choices and selections.

A further feature and capability of embodiments of present invention is use of passive or active color filters and diffusers to produce enhanced lighting effects.

In addition, protection can be enabled (or disabled) by microcontroller(s), microprocessor(s), FPGAs, CLDs, PLDs, digital logic, etc. including remotely via wireless or wired connections, based on but not limited to, for example, a sequence of events and/or fault or no-fault conditions, sensor, monitoring, detection, safe operation, etc.

An example of protection detection/sensing can include measuring/detecting/sensing lower current than expected due to, for example, a human person being in series with (e.g., in between) one leg of the LED, OLED and/or QD replacement fluorescent lamp and one side of the power being provided by the energized ballast.

The present invention can use microcontroller(s), microprocessor(s), FPGA(s), other firmware and/or software means, digital state functions, etc. to accomplish protection, control, monitoring, operation, etc.

In addition to using a switching element, a linear regulation/regulator instead of switching regulation/regulator can be used or both linear and switching regulation or combinations of both can be used in embodiments of the present invention.

Rapid start ballasts with heater connections may be made operable using resistors and/or capacitors. Certain implementations require less power and also evenly divide and resistance or reactive (e.g., capacitive and/or inductive) impedances so as to reduce or minimize power losses for the current supplied to the fluorescent lamp replacement(s). An example when having power supplied from an instant start or other ballast without heater(s) with only one electrical connection per ‘side’ of the fluorescent tube/lamp or fluorescent tube replacement (for a total of two connections) the resistors are effectively put into parallel thus reducing the resistance by a factor of four compared to being in serial for, for example, a heater emulation circuit or as part of a heater emulation circuit. Such heater circuits can contain resistors, capacitors, inductors, transformers, transistors, switches, diodes, silicon controlled rectifiers (SCR), triacs, other types of semiconductors and ICs including but not limited to op amps, comparators, timers, counters, microcontroller(s), microprocessors, DSPs, FPGAs, ASICs, CLDs, AND, NOR, Inverters and other types of Boolean logic digital components, combinations of the above, etc.

In some embodiments of the present invention, a switch may be put (at an appropriate location) in between the ballast output and the fluorescent lamp/fluorescent lamp replacement such that there is no completion of current flow in the fluorescent lamp replacement to act as a protection including shock hazard protection for humans and other living creatures in the event of an improper installation or attempt at or during installation. The detection of a such a fault or improper installation can be done by any method including analog and/or digital circuits including, but not limited to, op amps, comparators, voltage reference, current references, current sensing, voltage sensing, mechanical sensing, etc., microcontrollers, microprocessors, FPGAs, CLDs, wireless transmission, wireless sensing, optical sensing, motion sensing, light/daylight/etc. sensing, gesturing, sonar, infrared, visible light sensing, etc. A microprocessor or other alternative including, but not limited to, those discussed herein may be used to enable or disable protection and may be combined with other functions, features, controls, monitoring, etc. to improve the safety and performance of the present invention including before, during, after dimming, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

The present invention can work with programmable soft start ballasts including being able to also have a soft short at turn-on which then allows the input voltage to rise to its running and operational level can also be included in various implementations and embodiments of the present invention.

Some embodiments of the present invention utilize high frequency diodes including high frequency diode bridges and current to voltage conversion to transform the ballast output into a suitable form so as to be able to work with existing AC line input PFC-LED circuits and drivers. Some other embodiments of the present invention utilize high-frequency diodes to transform the AC output of the electronic ballast (or the low frequency AC output of a magnetic ballast into a direct current (DC) format that can be used directly or with further current or voltage regulation to power and driver LEDs for a fluorescent lamp replacement. Embodiments of the present invention can be used to convert the low frequency (i.e., typically 50 or 60 Hz) magnetic ballast AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figures and embodiments shown in herein are merely intended to provide some illustrations of the present inventions and not limiting in any way or form for the present inventions.

Using digital and/or analog designs and/or microcontrollers and /or microprocessors any and all practical combinations of control, protection, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of, for example, a comparator. Embodiments and implementations of the present invention allow for smooth ramping of the output of the SSL (e.g. LED, OLED, QD, etc.) from zero to full scale and allow for smooth dimming in response to manual controls, sensors, control and feedback in general.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or kilowatt hours (kWH), etc. of the load or loads connected to the present invention. In addition, in certain configurations and embodiments, some or all of the output electrical parameters may also be monitored and/or controlled directly for, for example, LED drivers and FL ballasts.

Such output parameters can include, but are not limited to, output current, output voltage, output power, duty cycle, PWM, dimming level(s), provide data monitoring, data logging, analytics, analysis, etc. including, but not limited to, input and output current, voltage, power, phase angle, real power, light output (lumens, lux), dimming level if appropriate, kilowatt hours (kWH), efficiency, temperature including temperatures of components, driver, LED or OLED array or array or strings or other types of configurations and groupings, etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, DALI, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, Bluetooth, etc.), powerline (PLC) including X-10, Insteon, HomePlug, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc.

Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, infrared motion, gesture, distance, etc. detection, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, digital isolators, digital galvanic isolators, digital to analog isolators, analog to digital isolators including but not limited to galvanic and/or optical isolation, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the some parts of the system, block or circuit may be implemented using its software or firmware equivalent while others are implemented in hardware circuits.

Embodiments of the present invention may also include short circuit protection (SCP) and other forms of protection including protection against damage due to other sources of power including but not limited to AC mains power lines and/or other types of devices, circuits, ballast output, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention. In some embodiments the capacitors may be replaced with shorts or resistors for use with low frequency (i.e., 50 Hz, 60 Hz, 400 Hz) magnetic ballasts.

The present invention can also incorporate at an appropriate location or locations one or more thermistors (i.e., either of a negative temperature coefficient [NTC] or a positive temperature coefficient [PTC]) to provide temperature-based load current limiting or current limiting in general. As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming

The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. The present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, RS422, IEEE standards, SPI, I2C, RS485, controller area network (CAN) bus, UARTs, Ethernet, Profibus, Modbus, etc., other serial and parallel standards and interfaces, etc.), wireless including as discussed above, powerline, etc. and can be implemented in any part of the circuit for the present invention.

The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments include an over-voltage protection (OVP) circuit that shunts/shorts or limits the ballast output and/or the output to the load such as a LED array in the event that the output voltage exceeds a set value.

Some embodiments include an over temperature protection (OTP) circuit that shunts/shorts or limits the ballast output and/or the output to the load such as a LED array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, Darlington transistors of any type and arrangement, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Also, in some embodiments and implementations of the present invention, part, most or all EMI circuits may be located in a different order than those shown in drawings of example embodiments.

The buck converter can also be a boost-buck, buck-boost, boost, etc. converter. The LED load could be LEDs, OLEDs, QDs, combinations of these, etc. The converter can have over-voltage protection (OVP), over-temperature protection (OTP), over-current protection (OCP), shock hazard/pin safety protection, constant current, etc.

The present invention including embodiments depicted in the figures can be used with AC line voltage including but not limited to 80 to 305 VAC 50/60 Hz, 347 VAC 50/60 Hz, 480 VAC, other 50/60 Hz voltages, magnetic and electronic ballasts, low frequency and high frequency ballasts, instant start, rapid start, programmed start, program start, pre-start, warm, cold, hot types of ballasts, etc.

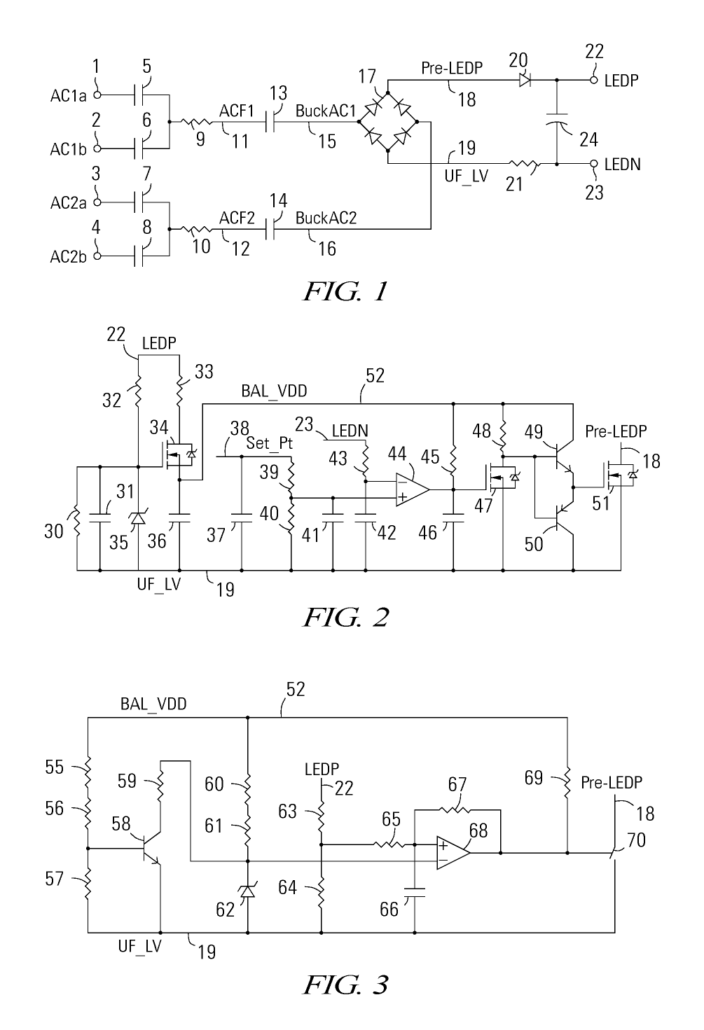

Turning to FIG. 1, a schematic version of the present invention is depicted including inputs 1, 2, 3, 4 for, for example, two pairs of bi-pin connections to a ballast and tombstone in a fluorescent lamp fixture, which can include a buck switching circuit that can be used with both a ballast or AC line which can also be optionally remote controlled and have features including OTP, OVP, SCP, dither, etc. and can be used with all types of ballasts including electronic rapid start, instant start, programmed start, preheat, magnetic, etc. that can be remote controlled and monitored and also has remote control/dimming Input coupling capacitors 5, 6, 7, 8, 13, 14 and resistors 9, 10 can be included along with, if desired, any other heater emulation or other input conditioning elements in any configuration. For example, resistors can be connected in parallel with each of the input coupling capacitors 5, 6, 7, 8. One or more rectifiers 17 can be included, as well as signal conditioning components and/or EMI components which can be included as desired, such as, but not limited to, diode 20, capacitors 24, as well as sensing components such as current sensing resistor(s) (e.g., 21) that can be used, for example, to sense the current through the output nodes LEDP 22, LEDN 23 which supply current to a solid state lighting load.

Turning to FIG. 2, ballast control circuit, also referred to as a one-shot or PWM-based shunt control circuit and over-voltage protection and/or over-temperature protection circuit, that can be used to control or disable the power supply of FIG. 1 is depicted in accordance with some embodiments of the invention. A regulator circuit including resistors 30, 32, 33, capacitors 31, 36, Zener diode 35 and transistor 34 provides a power signal Bal_VDD 52 based on load output LEDP 22 or another source. A voltage setpoint signal Set_Pt 38 is divided in voltage divider 39, 40 and optionally filtered with, for example, but not limited to, a time constant, for example established in part by capacitors 37, 41, and compared against the load return LEDN 23 or another reference through optional time constant 43, 42 in op-amp 44. An optional time constant can be applied to the output of the op-amp 44, for example by resistor 45, capacitor 46. The output of the op-amp 44 is buffered by transistor 47, resistor 48 before controlling a shunt switch which in one example embodiment includes BJT transistors 49, 50 and MOSFET 51.

Comparator or op-amp 44, resistors 45, 48, and transistor 47 comprise and form a one shot that feeds switch 49, 50, 51. Comparator or op-amp 44 compares a scaled version of the set point value 38 against a representative voltage of the current through the solid state light. When the voltage at the inverting input to op-amp 44 is greater than the voltage at the non-inverting input, then the output of op-amp 44 goes low and discharges capacitor 46 which, in turn, turns off transistor 47 which then switches on the switch 49, 50, 51 which then shunts current from Pre-LEDP 18 to UF_LV 19 in FIG. 1. When capacitor 46 charges to a voltage sufficient to turn on transistor 47, switch 49, 50, 51 is switched off and no longer shunts current. Diode 20, for example, in FIG. 1 prevents the voltage across the capacitor 24 and the voltage at outputs 22, 23 across the LEDs, OLEDs, and/or other SSLs from also being shorted out during the time duration that switch 49, 50, 51 is on.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc. Embodiments of the present invention can use, but are not limited to, fixed frequency, fixed pulse on time, fixed off time, fixed pulse width, etc., combinations of these, etc.

Turning to FIG. 3, an overvoltage or overtemperature control circuit that can be used to control or disable the power supply of FIG. 1 is depicted in accordance with some embodiments of the invention. A comparator 67, 68, 69 compares the output voltage 22 (divided and filtered as desired by resistors 63, 64, 65 and capacitor 66) against a reference voltage established by resistors 55, 56, 57, 59, 60, 61, transistor 58 and Zener diode 62. When the output voltage 22 rises above a threshold, switch 70 is closed to shunt current from Pre-LEDP 18 to UF_LV 19 in FIG. 1 to provide overvoltage protection. When the temperature rises, transistor 58 which has a temperature dependent base to emitter voltage that decreases by 2 mV per degree ° C., the reference voltage is temperature sensitive and switch 70 is closed to shunt current from Pre-LEDP 18 to UF_LV 19 in FIG. 1 when the temperature of the transistor (e.g., 58) rises above a threshold. Such a non-limiting implementation of the present invention may result in flashing of the LEDs at a certain or variable frequency or groups of frequencies.

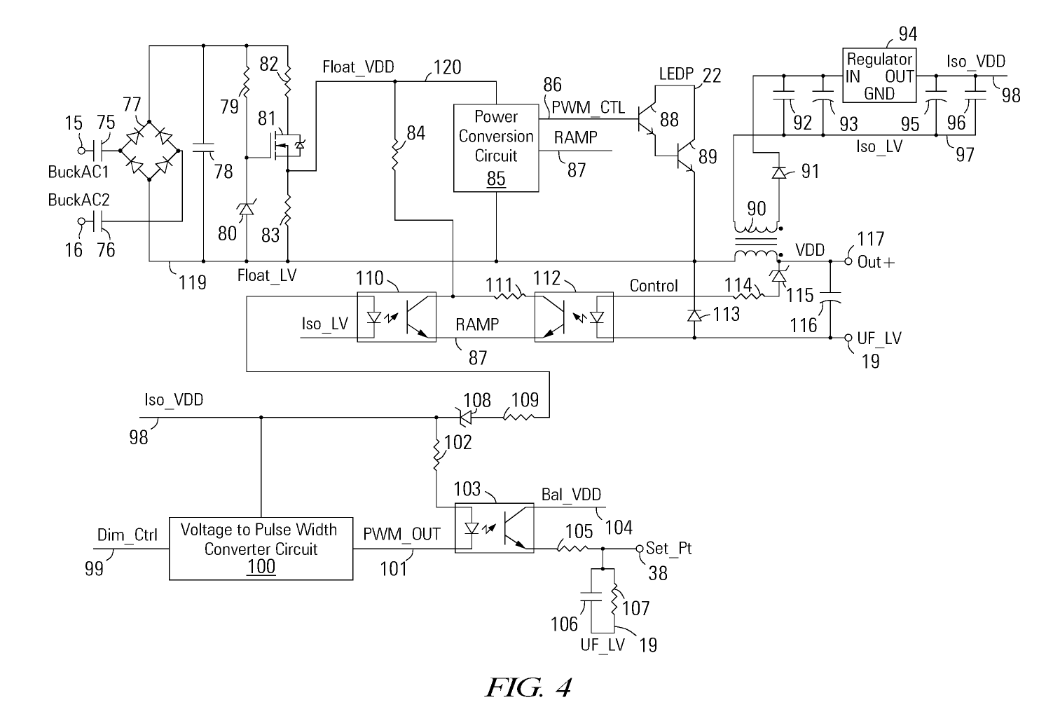

Turning to FIG. 4, a voltage to pulse width converter circuit that can be used to convert a voltage level such as an isolated voltage reference to a pulse width modulated signal based on a dimming control signal is depicted in accordance with some embodiments of the invention. Inputs 15, 16 receive power from the unrectified input points BuckAC1 15, BuckAC2 16 from FIG. 1 or from any other suitable source, which can be coupled through capacitors 75, 76, rectified in diode bridge 77, filtered by capacitor 78 and regulated in a voltage regulator such as that formed by transistor 81, Zener diode 80, and resistors 79, 82, 83 or any other suitable voltage regulator, yielding a DC voltage across DC rail Float_VDD 120 and floating ground Float_LV 119. A power conversion stage circuit 85 provides part of the power conversion between the DC voltage, such as, but not limited to, an example 15 VDC across DC rail Float_VDD 120 and ultimately an isolated low voltage Iso_VDD 98 such as, but not limited to, an example 3 VDC or 5 VDC or any other voltage level as needed. In some embodiments, the power conversion stage circuit 85 comprises a buck switching circuit, although other types of power conversion circuit such as, but not limited to, a buck-boost, boost, boost-buck, flyback, forward converters of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. In addition, a switching circuit may be used in place of the linear voltage regulators.

The output PWM_Ctl 86 of the power conversion stage circuit 85 drives a switch 88, 89 that couples the load output voltage LEDP 22 through a transformer 90 to an output Out+ 117. The output Out+ 117 can be used to power various devices or circuits in the lighting system or for other purposes, powering any desired application from the ballast power from the fluorescent lighting fixture.

An isolated voltage regulator is inductively coupled to the switched load output voltage LEDP 22 through an auxiliary winding of the transformer 90, which can be a tagalong winding, and diode 91. Other windings can be included in the transformer 90 for other purposes. A voltage regulator 94 and associated capacitors 92, 93, 95, 96 and any other suitable or desired components yields a regulated voltage Iso_VDD 94 and isolated ground Iso_LV 97, which are isolated from the load output LEDP 22 and which can be used for any purpose. Any linear regulator or other voltage regulator circuit can be used to generate the regulated voltage Iso_VDD 94. The voltage regulator can be over current protected, short current protected, over voltage protected, under voltage protected, over power protected.

A voltage to pulse width conversion circuit 100 generates the voltage setpoint signal Set_Pt 38 of FIG. 1 based on a dimming control signal Dim_Ctl 99, which can comprise a 0-3V or 0-10V or signal or any other suitable dimming control signal that indicates a desired dimming level at the load output LEDP 22. In some embodiments, the voltage level on the dimming control signal Dim_Ctl 99 represents the desired percentage of full output current that should be provided at the load output LEDP 22. The voltage to pulse width conversion circuit 100 is powered by the isolated voltage Iso_VDD 94 and yields a pulse width modulated signal PWM_OUT 101. An opto-isolator 103 and current limiting resistor 102 are driven by the voltage between the isolated voltage Iso_VDD 94 and the pulse width modulated signal PWM_OUT 101. The voltage setpoint signal Set_Pt 38 is produced based on a Bal_VDD voltage 104, controlled by the opto-isolator 103, and divided and filtered as desired, for example, by resistors 105, 107 and capacitor 106. The input can be a DC voltage, an oscillating voltage, a pulse signal, a pulse width modulation signal, etc.

Notably, the opto-isolators (e.g., 103) shown herein are merely examples, and any kind of isolation circuit or device can be used, such as, but not limited to, transformers or inductors with tagalong windings, etc.

In some embodiments, an isolated control feedback can be used to change the control point of the pulse width modulation in the power conversion circuit 85, thereby setting the voltage at output Out+ 117. A Zener diode 115 and current limiting resistor 114 are connected between the output Out+ 117 and ground reference UF_LV 19, with optional filtering capacitor 116. When the voltage between the output Out+ 117 and ground reference UF_LV 19 exceed a threshold such as, but not limited to, SVDC, Zener diode 115 will conduct and turn on opto-isolator 112, which changes the control point RAMP 87 of the pulse width modulation in the power conversion circuit 85 to set the voltage at output Out+ 117. DC output Out+ 117 can be used for any desired application, such as, but not limited to, powering circuits, devices, sensors, peripherals etc. in the fluorescent lamp replacement solid state lighting system.

In some embodiments, the control point RAMP 87 of the pulse width modulation in the power conversion circuit 85 to set the voltage at output Out+ 117 is also controlled by the isolated voltage Iso_VDD 94 to prevent the isolated voltage Iso_VDD 94 from exceeding a threshold voltage, for example 5VDC. A Zener diode 108, current limiting resistor 109 and opto-isolator 110 are connected between the isolated voltage Iso_VDD 94 and isolated ground reference Iso_LV 17. When the isolated voltage Iso_VDD 94 exceeds the threshold, Zener diode 108 conducts, turning on opto-isolator 110, which changes the control point RAMP 87 of the pulse width modulation in the power conversion circuit 85, lowering the current through transformer 90 and reducing the isolated voltage Iso_VDD 94.

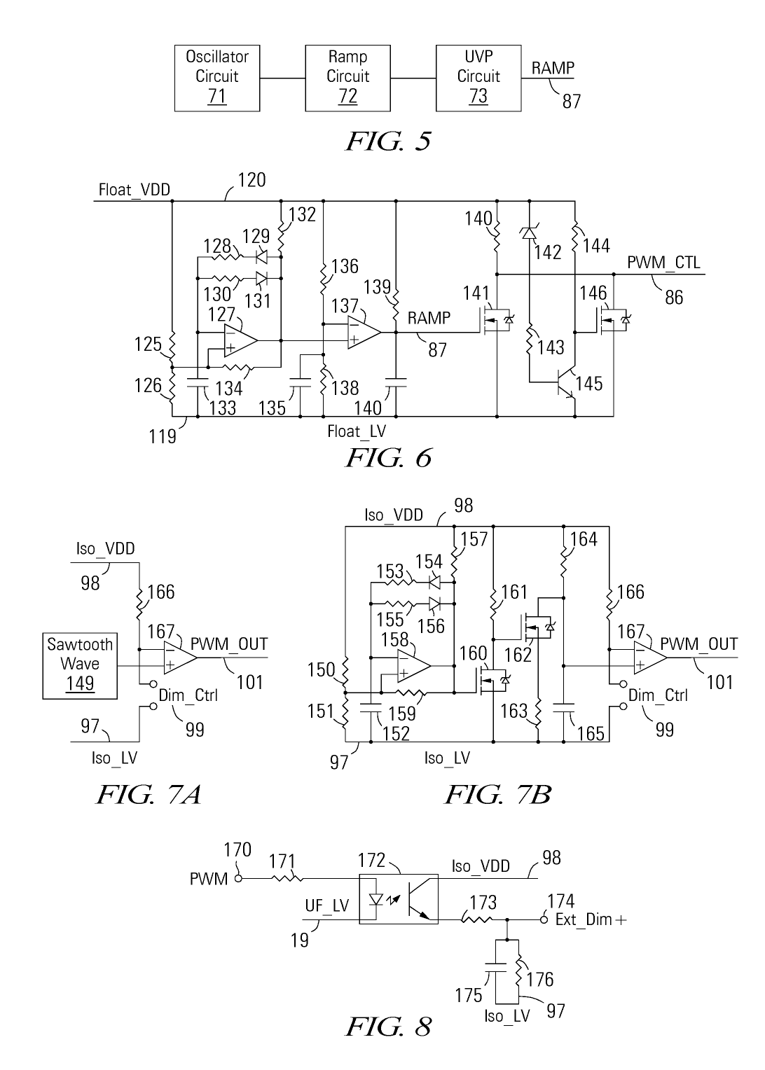

Turning to FIG. 5, a power conversion stage circuit is depicted in accordance with some embodiments of the invention which can be used in place of the power conversion stage circuit 85. A ramp circuit 72 generates a ramp signal 87 based on the output of an oscillator 71. Any suitable oscillator or ramp circuit can be used, and the power conversion stage circuit is not limited to any particular oscillator or ramp circuit. An undervoltage protection circuit 73 can be included in some embodiments to disable the ramp signal 87 when the supply voltage is below a threshold. In addition, any circuit that performs the same function can be used in place of the oscillator and/or ramp circuits such as a pulse generator or in some embodiments a pulse width generator.

Turning to FIG. 6, a power conversion stage circuit is depicted in accordance with some embodiments of the invention which can be used in place of the power conversion stage circuit 85. Although a buck circuit is used in the example embodiment of FIG. 6, other topologies can be used for power conversion, such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. Based upon the disclosure herein, one of ordinary skill in the art will recognize a number of power conversion stage circuits that can be used in place of the power conversion stage circuit 85.

In some embodiments, the power conversion stage circuit includes a voltage ramp circuit including comparator127, diodes 129, 131, and associated resistors 125, 126, 128, 130, 132, 134 and capacitor 135 generates a ramp signal at the non-inverting input of comparator137. Comparator137 compares the ramp signal against a reference voltage, which can be generated from Float_VDD 120 by resistors 136, 138 and capacitor 135, yielding a pulse width modulated signal RAMP 87. The pulse width modulated signal RAMP 87 can be buffered by transistor 141 and resistor 140 to yield pulse width modulated control signal PWM_CTL 86. Undervoltage protection can be provided by Zener diode 142, resistor 143, transistors 145 and 146, and resistor 144.

Turning to FIG. 7A, a voltage to pulse width converter circuit is depicted in accordance with some embodiments of the invention. A sawtooth wave generator circuit 149 provides a sawtooth wave or another reference wave with any shape of varying voltage to the non-inverting input of a comparator or op-amp, etc. 167.

The voltage to pulse width converter circuit receives a voltage-based dimming control signal Dim_Ctrl 99, which represents the desired output dimming level for the solid state lights by the voltage level between a maximum and minimum level, for example the level of the voltage between a maximum of 3 VDC and a minimum of 0 VDC (referred to as a 0-3V dimming control signal) or between a maximum of 10 VDC and a minimum of 0 VDC (referred to as a 0-10V dimming control signal), etc. The voltage to pulse width converter circuit converts the voltage-based dimming control signal Dim_Ctrl 99 to a pulse width-based dimming control signal PWM_OUT 101, which can be further isolated for example using opto-isolator 103 to yield an isolated pulse width-based voltage setpoint signal Set_Pt 38 that is used to dim the output to the solid state lights.

When there is no input on voltage-based dimming control signal Dim_Ctrl 99 pulling the inverting input of op-amp or comparator, etc. 167 down below Iso-VDD 98, resistor 166 pulls the inverting input of op-amp or comparator 167 up to Iso-VDD 98 which results in the maximum, un-dimmed output to the solid state lights at LEDP 22. When the voltage-based dimming control signal Dim_Ctrl 99 is pulled to OV, the ramp signal will always be higher than the voltage at the inverting input of op-amp 167 from the sawtooth wave circuit 149, causing the op-amp or comparator 167 to remain on which turns off the opto-isolator 103 of FIG. 4, disabling the voltage setpoint signal Set_Pt 38. When the voltage-based dimming control signal Dim_Ctrl 99 is set at a voltage somewhere between the ground reference Iso_LV 97 and the isolated voltage Iso_VDD 98, the output of the op-amp or comparator 167 will oscillate with the pulse width set by the level of the dimming control signal Dim_Ctrl 99.

Turning to FIG. 7B, an example implementation of a voltage to pulse width converter circuit is depicted in accordance with some embodiments of the invention. The voltage to pulse width converter circuit is not limited to this example embodiment, and one of skill in the art will recognize a variety of voltage to pulse width converter circuits that can be used in connection with various embodiments of the invention. The voltage to pulse width converter circuit receives a voltage-based dimming control signal Dim_Ctrl 99, which represents the desired output dimming level for the solid state lights by the voltage level between a maximum and minimum level, for example the level of the voltage between a maximum of 3 VDC and a minimum of 0 VDC (referred to as a 0-3V dimming control signal) or between a maximum of 10 VDC and a minimum of 0 VDC (referred to as a 0-10V dimming control signal), etc. The voltage to pulse width converter circuit converts the voltage-based dimming control signal Dim_Ctrl 99 to a pulse width-based dimming control signal PWM_OUT 101, which can be further isolated for example using opto-isolator 103 to yield an isolated pulse width-based voltage setpoint signal Set_Pt 38 that is used to dim the output to the solid state lights.

A voltage ramp circuit, which can be powered by the isolated voltage Iso_VDD 98, including op-amp 158, diodes 154, 156, transistors 160, 162 and associated resistors 150, 151, 153, 155, 157, 159, 161, 163 and capacitor 152 generates a ramp signal at the non-inverting input of op-amp or comparator or similar function 167. In some embodiments, the voltage ramp circuit is powered by the isolated voltage Iso_VDD 98. When there is no input on voltage-based dimming control signal Dim_Ctrl 99 pulling the inverting input of op-amp or comparator, etc. 167 down below Iso-VDD 98, resistor 166 pulls the inverting input of op-amp or comparator 167 up to Iso-VDD 98 which results in the maximum, un-dimmed output to the solid state lights at LEDP 22. When the voltage-based dimming control signal Dim_Ctrl 99 is pulled to 0V, the ramp signal will always be higher than the voltage at the inverting input of op-amp 167, causing the op-amp or comparator 167 to remain on which turns off the opto-isolator 103 of FIG. 4, disabling the voltage setpoint signal Set_Pt 38. When the voltage-based dimming control signal Dim_Ctrl 99 is set at a voltage somewhere between the ground reference Iso_LV 97 and the isolated voltage Iso_VDD 98, the output of the op-amp or comparator 167 will oscillate with the pulse width set by the level of the dimming control signal Dim_Ctrl 99.

Turning to FIG. 8, an example follower dimming circuit is depicted that isolates a dimming control signal in accordance with some embodiments of the invention. The isolation provided by the follower dimming circuit can be used as desired to isolate any signal in the solid state lighting system, such as, but not limited to, a pulse width modulated dimming control signal 170 that can be provided by a microcontroller, a PWM dimming control circuit, a DC level-based control circuit, or any other suitable source. In some embodiments, isolation is provided by an opto-isolator 172 and current limiting resistor 171, and the isolated output signal 174 is based on an isolated supply voltage Iso_VDD 98, voltage-divided and filtered for example by resistors 173, 176 and capacitor 175. Notably, the opto-isolator 172 shown herein is merely a non-limiting example, and any kind of isolation circuit or device can be used, such as, but not limited to, transformers or inductors with tagalong windings, etc.

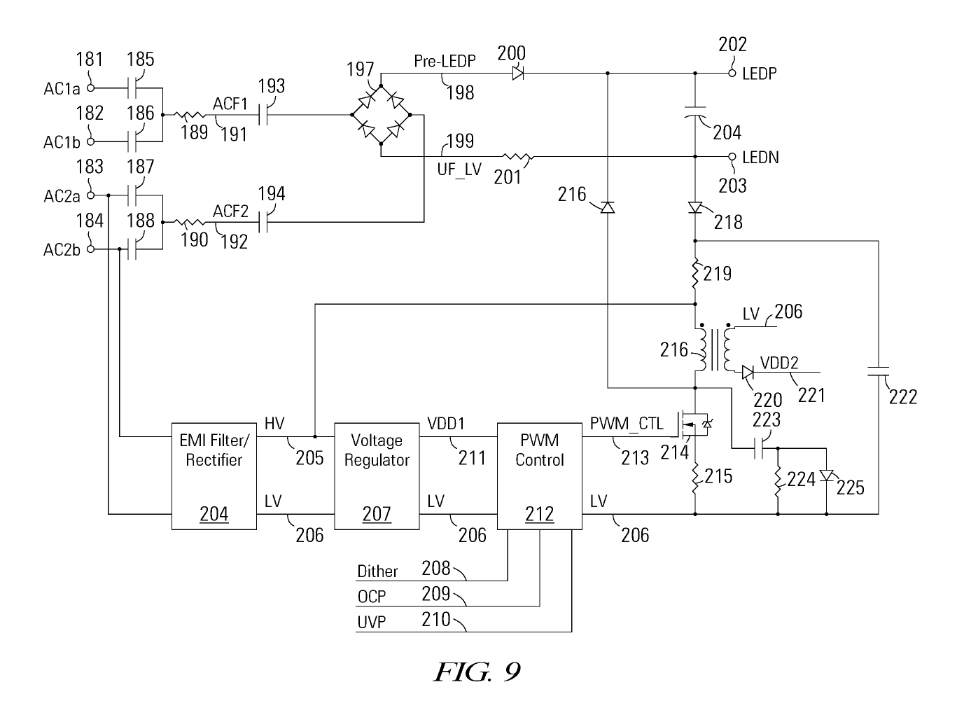

Turning to FIG. 9, a solid state lighting power supply is depicted that can draw power from a fluorescent lamp fixture in accordance with some embodiments of the invention, wherein ballasted power can be drawn from bi-pins 181, 182, 183, 184 at both ends of the lamp fixture when a fluorescent ballast is installed in the fixture, or AC power can be drawn from bi-pins 183, 184 just one end of the lamp fixture when the fluorescent ballast is not installed or has been removed from the fixture. The solid state lighting power supply can be used with all types of ballasts including electronic rapid start, instant start, programmed start, preheat, magnetic, etc. that can be remote controlled and monitored and also has remote control/dimming In some embodiments of the present invention, some of the capacitors may be replaced, for example, but not limited to, with shorts and/or resistors.

When an electronic ballast is installed and functioning in the fluorescent lamp fixture, high frequency current flows between the bi-pins 181, 182 at one end of the lamp fixture and the bi-pins 183, 184 at the other end of the lamp fixture, and the solid state lighting power supply draws from this power to power a load connected to output nodes LEDP 202, LEDN 203. In ballast-powered operation, power is drawn through AC coupling capacitors 185, 186, 187, 188 and resistors 189, 190, which can be included along with, if desired, any other heater emulation or other input conditioning elements in any configuration to enable the ballast to function normally. Some or all of these capacitors may be optional in some embodiments of the present invention. For example, one or more resistors can each be connected in parallel with each of the input coupling capacitors 185, 186, 187, 188. One or more rectifiers 197 can be included, as well as signal conditioning components and/or EMI components which can be included as desired, such as, but not limited to, diodes 200, capacitors 204, as well as sensing components such as current sensing resistor(s) (e.g., 201) that can be used, for example, to sense the current through the output nodes LEDP 202, LEDN 203 which supply current to a solid state lighting load.

When the ballast is not installed in the fluorescent lamp fixture, AC line power is drawn from the pair of bi-pins 183, 184 at one end of the lamp fixture. An EMI filter/rectifier 204 filters and rectifies the input power to yield a rectified AC signal HV 205, which is at or near the line voltage and is therefore referred to herein as a high voltage signal in comparison with lower DC voltages (e.g., 15 VDC, 5 VDC, 3 VDC, etc.) that can be generated in the solid state lighting power supply to power circuits in the solid state lighting power supply or any other desired load.

A voltage regulator 207 regulates the rectified AC signal HV 205 to yield a lower voltage DC signal VDD1 211, used to power at least a pulse width modulation control circuit 212. The voltage regulator 207 can be a linear regulator or can comprise a buck converter circuit or, in other embodiments, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc.

In some embodiments, a dither signal 208, over-current protection 209, under-voltage protection 210, or any other control and protection signals and circuits can be used with the PWM control or other type of pulse control 212, including but not limited to over-temperature protection, over-voltage protection, etc.

The pulse width modulation control circuit 212 generates a pulse width modulated control signal PWM_CTL 213 to control the current drawn from the rectified AC signal HV 205 and supplied to the output nodes LEDP 202, LEDN 203 in AC power mode. The pulse width modulated control signal PWM_CTL 213 controls a switch 214 which passes or blocks current between the rectified AC signal HV 205 and return signal LV 206 through the switch 214, a current sensing resistor 215 and an inductor 216 or transformer. The AC supply side is coupled to the output nodes LEDP 202, LEDN 203 by diodes 216, 218 and capacitor 222. In AC power mode, when the switch 214 is closed, current flows from the rectified AC signal HV 205, through inductor 216, diode 216 to output node LEDP 202, returning from output node LEDN 203, through diode 218, and capacitor 222. When the switch 214 is opened to control the average load current, power stored in inductor 216 flows through diode 216 to output node LEDP 202, returning from output node LEDN 203, through diode 218 and current sense resistor 219. Such a switching or storage circuit depicted in FIG. 8 can be, for example but not limited to a buck, buck-boost, boost-buck, boost, flyback, forward converter, SEPIC, Cuk, etc.

In some embodiments, power can be obtained through a tagalong winding on inductor 216 for other purposes, yielding power signal VDD2 221 through diode 220 which can be used for any purpose.

Dimming control can be applied to the pulse width modulation control circuit 212 in any suitable manner, for example using an isolated setpoint signal (e.g., 38) based on an external dimming control signal as in the example embodiments of FIGS. 1-4 to modify or control the pulse width of the pulse width modulated control signal PWM_CTL 213 from the pulse width modulation control circuit.

In some embodiments of the present invention, snubber and/or clamp circuits (e.g., including but not limited to capacitor 223, resistor 224 and diode 225) may be used with the rectification stages (which, for example, could be diodes or transistors operating in a synchronous mode) or elsewhere as shown; such snubbers could typically include capacitors, resistors and/or diodes or be of a lossless type of snubber where the energy is recycled or be made of capacitors only or resistors only, etc. Such snubbers can be of benefit in reducing radiated emissions and limiting the voltages seen by switching elements. Some embodiments of the present invention can use lossless snubbers.

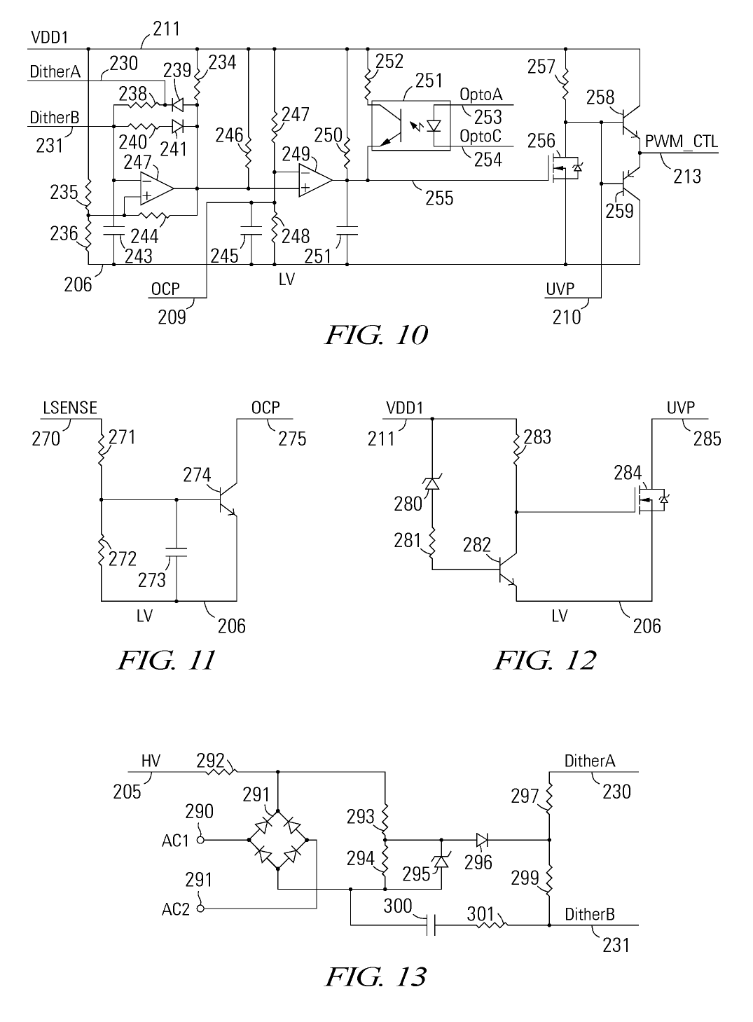

Turning to FIG. 10, a power conversion stage circuit is depicted in accordance with some embodiments of the invention which can be used in place of the voltage regulator 207. The power conversion stage circuit includes a voltage ramp circuit including op-amp or comparator 247, diodes 239, 241, resistors 234, 235, 236, 238, 240, 244, 246 and capacitor 243 that generates a ramp signal at the non-inverting input of op-amp 249. Op-amp 249 compares the ramp signal against a reference voltage, which can be generated from VDD1 211 by resistors 247, 248 and capacitor 245, yielding a pulse width modulated signal 255. The pulse width modulated signal 255 can be buffered by transistors 256, 258, 259 and resistor 257 to yield pulse width modulated control signal PWM_CTL 213. FIG. 10 is intended to be a non-limiting example and is illustrative of the present invention. Any such circuit or circuits including ones in an integrated circuit form that performs a similar or the same function as shown in FIG. 10 can be used as part of the present invention.

Dithering can be applied in the power conversion stage circuit, for example at nodes DitherA 230 and DitherB 231. Dithering of, for example, but not limited to, frequency, duty cycle, width, etc. may be used with the example embodiments shown herein and in general for the present invention to, for example, provide EMI dithering and reduction.

Other protection circuits can be used to control the power conversion stage circuit, for example by applying an overcurrent protection signal 209 at the inverting input to op-amp or comparator 249, an undervoltage protection signal 210 can be applied at the base of transistors 258, 259, etc. Again, the types of circuit protection and the circuit nodes at which they are applied are not limited to these examples. Other control signals (e.g., OptoA 253, OptoC 254) can be applied, for example through opto-isolator 251 and resistor 252. For example, output voltage limiting can be applied in this manner

Turning to FIG. 11, an overcurrent protection circuit is depicted in accordance with some embodiments of the invention. A current level signal LSENSE 270, derived, for example, from the voltage level across resistor 215 in FIG. 9 or any other suitable source, is divided and filtered as desired, for example by resistors 271, 272 and capacitor 273 to drive transistor 274. When the current level becomes excessive, the transistor 274 pulls down an overcurrent signal OCP 209 and limits the current.

Turning to FIG. 12, an undervoltage protection circuit is depicted in accordance with some embodiments of the invention. When a voltage signal VDD1 211 falls too low, a Zener diode 280 and resistor 281 turn off transistor 282, pulling up the gate of transistor 284 through resistor 283 and turning on transistor 284, which pulls down the undervoltage signal UVP 285. The undervoltage signal UVP 285 can be used, for example, to disable transistors 258, 259 in FIG. 10 to turn off the pulses on the pulse width modulated or variable pulse control signal PWM_CTL 213.

Turning to FIG. 13, a dither circuit is depicted in accordance with some embodiments of the invention. AC power taken from inputs 290, 291 connected, for example, in EMI Filter/Rectifier 204 before rectification, is rectified in diode bridge 291, referenced to HV 205 through resistor 292. Voltage divider 293, 294 and Zener diode 295 generate a reference voltage, passed through diode 296. A low side dither signal DitherB 231 is tied to the low side of diode bridge 291 through capacitor 300 and resistor 301. A voltage divider 297, 299 generates the high side dither signal DitherA 230 based on the output of diode 296. The dither circuit can be used, for example, to alter the feedback paths to op-amp 247 in the ramp generator of the power conversion stage circuit of FIG. 10 to, for example, provide EMI dithering and reduction. Again, dithering is an optional feature in some embodiments of the solid state lighting system, and can be applied using an circuit or device, applied at any suitable point and in any suitable manner in the solid state lighting system.

The solid state lighting system is a versatile and flexible system that can be used and applied in a number of manners and settings. In one embodiment, lighting is controlled based on inputs from one or more sensors of any type. Such a process may include, but is not limited to:
Set the Time Duration after Sensing/Detecting/etc. Select the methods/Sensors/detectors/etc. Set the detection threshold(s). Set/program other parameters, data, requirements, etc. Set the time off type: Instant off/dimming to off, duration to off, dimming parameters, etc.
Wait for Sensing/Detection/Triggering/Tripping/Activation/etc. along with other Information/Dependencies/Situation/Specific Parameters, etc.
After sensing detected, begin process to turn on/activate the lighting while gathering information such as, for example, but not limited to source of sensing/detection (known or unknown source), lookup information in database(s), web, etc., anticipate path and which lights and other services need to be turned on, dimmed, or, for example, which can be left turn off due to, for example, daylight harvesting, etc. Decide if situation requires alerting, alarming, etc. Decide whether to use lights as part of the alarm, etc. Complete needed data gathering and decision making
Turn on and/or dim lighting at a pre, during, post set of time duration(s) based on data gathering/decision making and/or other sensors/detectors/etc., including potentially user input, preferences, etc. Time duration(s) can range from less than 1 second to greater than 1 hour, 1 day, etc.

In some embodiments, a voice recognition system is included to select lighting configurations and settings. Any voice commands can be used and programmed, such as, for example, Light, dim level 3; Light, white dim level 7; Light, blue dim level 8.

Combinations of WiFi, Bluetooth, Bluetooth Low Energy (BLE), ISM, ZigBee, 6LoWPAN, Zwave, sub-GHz, etc., other radio frequencies, etc. can be included and combined to provide a network such that the lighting system is able to communicate lighting commands and status, etc., via such a hybrid network. In some configurations of the present invention, the system may use one or more WiFi (or, for example, 6LoWPAN based on IEEE 802.15.4) networks to transmit the control and monitoring communications signals from one location to another and then use a WiFi to Bluetooth (such as a Bluetooth mesh) adapter to locally control/monitor the lighting. Some embodiments of the present invention also include BACNET or other network to wireless adapters including but not limited to BACNET to WiFi and/or BACNET to Bluetooth and/or BACNET to other frequencies including RF frequencies including but not limited to communications within a building or buildings including but not limited to indoor and outdoor lighting, temperature, water, humidity, etc.

The solid state lighting system can include multicolor devices or multicolor combinations of devices, which can be used for any purpose, such as, but not limited to, festive lighting including for holidays (Christmas, Hanukkah, New Years, Easter, Halloween, Fourth of July, St Patrick's Day, etc.), favorite/local (high school, college, university, professional (such as but not including but not limited to football, soccer, baseball, lacrosse, softball, basketball, hockey, tennis, gymnastics, etc.) team, company, state, personal, college, university, etc., colors, etc.

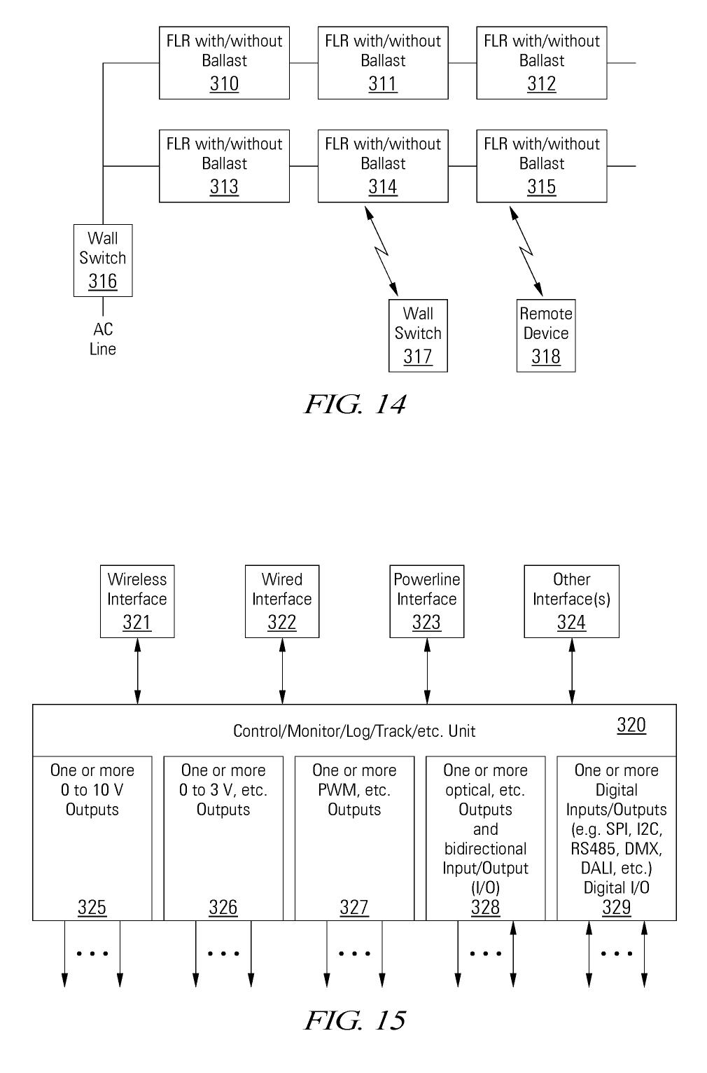

Turning to FIG. 14, some examples of the solid state lighting system include multiple fluorescent lamp replacements 311, 312, 313, 314, 315 and multiple control devices such as, but not limited to wired wall switch 316, wireless wall switch 317, remote control device(s) 318 such as cell phones, tablets, computers, etc., which can be networked and interconnected in any suitable manner or using a combination of wired and wireless networks. Remote control device(s) 318 can be powered in any manner, for example using AC line, battery, solar, power over Ethernet (POE), mechanical generators, vibrational power harvesters, energy harvesters in general, etc.

Some embodiments of the present invention include a fluorescent tube replacement such as a T4, T5, T8, T10, T12, etc. that can use a motor or similar device to raster or scan the SSL/LED lighting which can include but is not limited to one or more white color temperatures, one or more colors including but not limited to red, green, blue, amber, yellow, etc., combinations of these, etc. Implementations of the present invention can include but is not limited to addressable arrays of LEDs including one or more different white color temperatures (W, WW, WWW, etc.) and colors such as RGB, RGBA, etc.

Implementations of the present invention can measure the input current, voltage, power, power factor, etc. of, for example, but not limited to, each unit (lamp), the group or groups of lamps controlled by a ‘wall dimmer’ of the present invention, etc. By measuring such input power used/consumed, implementations of the present invention can measure/calculate/determine/etc. the power/energy consumed and the both the energy (which essentially equals power×time) consumed and the energy saved for example, but not limited to, for the SSL/LED direct fluorescent replacement lamp that, for example, uses a ballast or a SSL/LED AC retrofit fluorescent replacement lamp that runs directly off the AC power and use such information to calculate the energy savings including but not limited to the energy savings based on the difference between the old/previous fluorescent lamp with ballast. Using such energy savings measurements/calculations/determinations/etc., the monetary savings value can be calculated/deduced/determined, etc. from the energy cost rate for example, but not limited to, by using the energy cost in, for example, but not limited to, multiplying the energy (equals power times time) in for example, but not limited to, kilowatthours (kWH) times the rate (in, for example, dollars per kWH=$/kWH) to determine the financial monetary savings. Such monetary savings can be used as the basis for determining the return on investment or, for example, to determine the value of a leasing agreement, etc. Such information, determinations, processing, etc. can be done, stored, compiled, performed, etc. by firmware, software, etc., stored anywhere in one or more locations, including but not limited and not necessarily in embodiments and implementations of the present invention, etc.

Embodiments of the present invention include dimming/control units that can also optionally measure and monitor and log data, information, performance, etc. Such embodiments can use 0 to 10 V, 0 to 3 V, other analog protocols, ranges, etc., powerline communications, wireless, wired other digital protocols, etc., forward or reverse phase dimming of any kind and type including ones that involve one or more of triacs, transistors, diodes, etc., combinations of these, etc. and can use light level motion, ultrasonic, noise, sound, voice, etc.

Embodiments of the present invention can be used to replace, for example, 32 Watt 4 ft. linear fluorescent T8s with lower wattage LEDs that can be increased manually or automatically by, for example, but not limited to, switches, software, hardware, firmware, etc.

The solid state lighting can use proximity and signal strength of Cellular phone, smart phone, tablet, RFID tag, etc. to turn on the lights if it recognizes the phone as someone walks past the smart dimmer switch with a known ID such as a known Bluetooth previously joined/connected phone. Such a turning on can be to a particular light intensity/dimming level and a particular color temperature. If an unknown ID, for example but not limited to, a Bluetooth ID passes by, the smart dimmer could do one of many things including but not limited to, flashing the lights on and off, alerting including alerting by one or more of alarm, e-mail, text message, web alert, sending photos, flashing the lights one or more color or color temperatures, making audible sounds, setting off alarms, including but not limited to audible alarms, silent alarms, sirens, etc., combinations of these, etc. or turning on the lights to a prescribed value and color temperature or color, etc.

The solid state lighting can have permission levels and priorities, etc.

Some embodiments of the dimmer for the present invention can use a diode bridge with a transistor. Some embodiments of the present invention can also use a Triac in parallel with, for example, but not limited to the one or more diode bridge(s) and the one or more transistor(s)/switches.

Some embodiments of the present invention can use a smart relay, transistor, triac, other types of semiconductor switch, circuit breaker that, in addition to performing normal circuit breaker functions, can be turned on and off by wired, wireless and/or powerline communications. The relay or relays can be of type, form, principle of operation, etc. including but not limited to latching and non-latching relays.

Various embodiments and implementations of the present invention can work with virtually any type of ballast including all types of magnetic and electronic ballasts and high intensity discharge (HID) ballasts of any type and form and, regardless of the ballast or HID type and ability (i.e., a fixed power, non-dimmable, non-controllable, etc. ballast) make the ballast or HID and fluorescent or HID lamp replacement into a smart and intelligent system capable of virtually any control and monitoring including but not limited to daylight harvesting, dimming, motion, noise, audio, ultrasonic, sonar, radar, proximity, cell phone, RFID, light, solar, time of day, week, month, date, etc., web, environment, etc. sensing and responding, etc. one or two way communications, data logging, analytics, fault reporting, etc. and other functions, features, modes of operation, etc. discussed herein. Such embodiment and implementations can also be implemented to work directly with AC and/or DC power. Although primarily discussed in terms of fluorescent lamp replacements, all of the functions, abilities, capabilities, features, modes of operation, approaches, methods, techniques, technologies, designs, architectures, topology, etc. apply directly and equally to high intensity discharge (HID) lighting including but not limited to metal halide, various and all types of sodium and other gaseous low pressure and high pressure lighting, etc., other types of lighting discussed herein including various types of fluorescent lighting including but not limited to compact fluorescent lamps, PL and PLC fluorescent lamps, cold cathode fluorescent lamps, T1 through T13 fluorescent lamps including but not limited to T4, T5, T8, T12, fluorescent lamps of any length and shape including but not limited to linear, U-shaped, rectangular shape, one or more U-shaped lamps.

The heater emulation circuits may employ one more switches that can open or close as needed depending on for example, frequency of applied current, voltage, power, etc., temperature, operating conditions, etc., type of ballast, etc. Such one or more switches can be of any appropriate type or form including ones that are manually or automatically activated, mechanically or electrically activated, are semiconductor switches such as but not limited to field effect transistors (FETs) including but not limited to MOSFETs, JFETs, UFETs, etc., of both depletion and enhancement types, bipolar junction transistors including but not limited to PNP and NPN, heterojunction bipolar transistors (HBTs), unijunction transistors, triacs, silicon controlled rectifiers (SCRs), diacs, insulated gate bipolar transistors (IGBTs), GaN-based transistors including but not limited to GaNFETs, silicon carbide (SiC) based transistors including but not limited to SiCFETs, etc., solid state and mechanical relays, reed relays, electromechanical relays, latching relays, contactors, etc. photodiodes, phototransistors, optocouplers, etc. vacuum tubes, etc. thermistors, thermistor-based switches, etc. Temperature sensing can be accomplished using any technique including but not limited to thermistors, semiconductor junctions, thermocouple junctions, resistors, fuses, thermal methods, etc.

The present invention provides for convenient direct replacements for fluorescent, HID and other types of lighting using SSL including but not limited to LEDs, OLEDs, QDs, etc. that enables smart and intelligent operation where there was none before. Embodiments of the present invention provide for SSL FLRs that can perform smart and intelligent dimming and power reduction including autonomously, automatically, manually, with one-way or two-way (i.e., bidirectional) communications and reporting using smart local or remote sensors including but not limited to those discussed herein.

Such sensors can be manually, automatically, programmed, modified, set, determined, changed, etc. including locally and remotely. For example, a motion sensor can be programmed/set by, for example, but not limited to, an app on a phone, tablet, laptop, other personal digital assistant, other device, etc. for sensitivity, time on, time off, trigger level, distance, reporting level and status, alarms, etc. either locally or remotely via, for example, but not limited to, an phone/tablet app. In addition, embodiments and implementations of the present invention can also be set to monitor and report back any fault conditions including but not limited to power interruptions, power loss, improper operation, too little power, too much power, too much voltage (over voltage), too little voltage (under voltage), too little current (under current), too much current (over current), too little light output, too much light output, too high of a temperature, too low of a temperature, etc., arcing, damage, combinations of these, etc. and alert/request maintenance/repair, other types of functions including Internet of things (IOT) sensors, controls, devices, etc.

Any location, indoors or out, such as, but not limited to, bathroom, closet, stairwell, garage, conference room, other locations which may or may not be used frequently, etc. can make use of the ballast-compatible direct fluorescent lamp replacement embodiments of the present invention including but not limited to the smart/intelligent ones discussed herein. Embodiments and implementations of the present invention can be dimmed slowly, quickly, or at essentially any rate up and down and can be triggered to dim (up or down) via an app from a smart device such as smart phones (iPhones, Android or Windows phones), iPads, iPods, Android, Windows or other tablets, personal computers, laptops, servers, etc., motion sensors and detectors, daylight harvesters, gesture sensors, capacitive sensing, etc.,

Embodiments of the present invention can also monitor and report power, current, voltage usage to, for example, but not limited to, measure, determine and calculate energy and cost savings and to also, but not limited to, determine SSL/LED usage in terms of hours on and current through the SSL/LEDs to determine, estimate, extrapolate, calculate, etc. lifetime remaining, SSL/LED degradation, depreciation, etc. Optional temperature and/or light sensors may also be used to keep track, track, log, perform additional analytics including but not limited on the lifetime, performance, degradation, decrease in lumens, lumens depreciation, etc. of the SSL/LEDs, monitor the health of the lighting, etc.

The present invention can be used to replace any and all types of gaseous lighting including but not limited to fluorescent, HID, metal halide, sodium, low and/or high pressure lamps, etc. for parking lights, street lights, outdoor lights, indoor lights, sports lights, gymnasium lights, office lights, stair well lighting, virtually any type of indoor or outdoor lighting, stair case lights, bathrooms, closets, bedrooms, living rooms, family rooms, hospitals, hospital rooms, surgery rooms, urgent care, emergency care, classrooms, auditoriums, offices, lobbies, gyms, sports centers, community centers, recreational centers, call centers, data centers and associated offices, prisons, doctor's offices, dental offices, libraries including but not limited to libraries for schools, colleges, universities, public and private libraries, study areas, individual cubicle lighting including, for example, but not limited to individual lighting in a library where the lighting preference including, for example, but not limited to light intensity, color temperature, color rendering index (CRI), light pattern and location, etc., color lighting, etc. could be selected for/by, etc. each individual or user, etc. Implementations of the present invention can also be used for cleanroom applications including but not limited to photolithography applications and locations where the wavelength and associated energy, color, etc. must be restricted to typically a yellow color or below (i.e., to the red wavelengths as opposed to the blue wavelengths). For such implementations yellow SSL including but not limited to yellow phosphor coated (PC) SSLs including LEDs, OLEDs, QDs, etc. can be used to provide the appropriate and needed color of light while still being highly efficient and with long life.

The solid state lighting can incorporate control signals from emotion sensors and mood sensors.

The solid state lighting can be manufactured or provided in a variety of manners, such as, but not limited to, fluorescent lamp replacement kits, direct AC replacement kits, panels including panels of any size from inches (or less) on a side to feet on a size and larger including but not limited to 1×2 foot, 2×2 foot, 1×3 foot, 2×3 foot, 2×4 foot, 3×4 foot, 4×4 foot and larger (and also smaller), PLC lamps, PAR lamps, A lamps, R lamps, BR lamps, etc., any other type of lamp, light, light fixture, combinations of these, etc. Embodiments of the present invention can control, monitor, color change, color temperature change, etc. all types of lighting which can all be controlled by the same interface and control. Implementations of the present invention can use light sensors, color sensors, including white, clear, red, green, blue, amber, etc. sensors including but not limited to ones that are digitally interfaced, controlled and communicated to and with.

In some embodiments of the present invention, the lighting can be set/programmed including but not limited to active and/or dynamic processing and scene selection(s), programming, synchronizing, artificial intelligence, sequencing the lighting so that, for example but not limited to, the lighting being on, turned on/off, dimmed, etc. in certain ways, paths, etc. from less than one second to more than one hour. Such embodiments allow for special effects including the appearance that the light is following, leading, shadowing, tracking, anticipating, dimming up and down, etc., combinations of these, etc. the movement, direction, destination, or location, etc. that one or more people, living creatures, persons with permission, persons without permission, etc. may be heading to, going toward, etc. Such embodiments may use but are not limited to one or more motion sensing, radar, movement, vibration, sonar, ultrasonic, ultrasound, camera(s), vision recognition, pattern recognition, photocells, photo detector(s), electric eye(s), RFID, cell phone signals, smart phone signals, tablet signals, RF signal strength/detection including but not limited to Bluetooth, other 2.4 GHz, sub-GHz, ISM, WiFi, 6LoWPAN, ZWave, ZigBee, other types, protocols, frequencies, etc. discussed herein, including elsewhere in this document, etc., combinations of these, as well as other information including methods of identification, badge/sign-in entry, time of day, database information, web based information, signals, data, etc., day, date, weather, temperature, humidity, light level, solar/Sunlight level, gesturing, facial expressions, movements, ambient conditions, environment, track speed including but not limited to of a person or persons, etc., animal(s), other living creatures, animate or inanimate objects, etc. Such embodiments can make the speed of on/off and or dimming to whatever is desired, needed, required including from extremely fast to extremely slow including but not limited to fading in and out at any desired speed including different speed and time durations for fading on or off, respectively. Such embodiments may be used for any application or use including but not limited to indoor and/or outdoor applications including but not limited to hallways, rooms, meeting locations, conference rooms, conference centers, convention centers, sports events centers, to and from locations such as bathrooms, open or closed/covered parking lots and locations, street lighting, including but not limited to for pedestrians and vehicles, freeway and highway road and other lighting, signage lighting including but not limited to roadside and billboard lighting. Embodiments of the present invention can use the cloud and in general the Internet, to communicate to and from, to store information, to control and monitor devices and store, log, etc. information, settings, etc. that are part of the present invention, etc. and can include nodes, edge devices and routers, etc.

Embodiments of the present invention can have a wireless or wired device provide one or more and especially more than one 0 to 3 V and/or 0 to 10 V or other analog and/or digital signals including but not limited to simple and/or complex pulsing including simple to complex and sophisticated PWM. Such embodiments can control/monitor/log/store/analyze/perform analytics, etc. on more than just the lighting and can also be used to do different things including but not limited to heat, cool, light, protect, detect, etc. A non-limiting example of such an embodiment of the present invention is shown in FIG. 15, which can include one or more Control/Monitor/Log/Tracking circuits 320 that receives control input from any available source, such as, but not limited to, wired interfaces 321, wireless interfaces 322, powerline interfaces 323, and other interfaces 324. The Control/Monitor/Log/Tracking circuits 320 can include microcontrollers/microprocessors or other control systems to gather the commands, gather and log information, and generate appropriate corresponding commands to one or more fluorescent lamp replacements through one or more interfaces, such as, but not limited to, one or more 10V outputs 325, one or more 3V outputs 326, one or more PWM, etc., outputs 327, one or more optical, etc. outputs and bidirectional Inputs/Outputs(I/O) 328, one or more digital inputs/outputs (e.g. SPI, I2C, RS485, DMX, DALI, others discussed elsewhere in this document, etc.) digital I/O 329, etc. Such implementations can be used for more than lighting and include but are not limited to heating, cooling, HVAC, temperature, humidity, window coverings, entertainment, etc. as well as lighting including specialized lighting and general lighting. Embodiments of FIG. 15 can also use and be powered by POE.

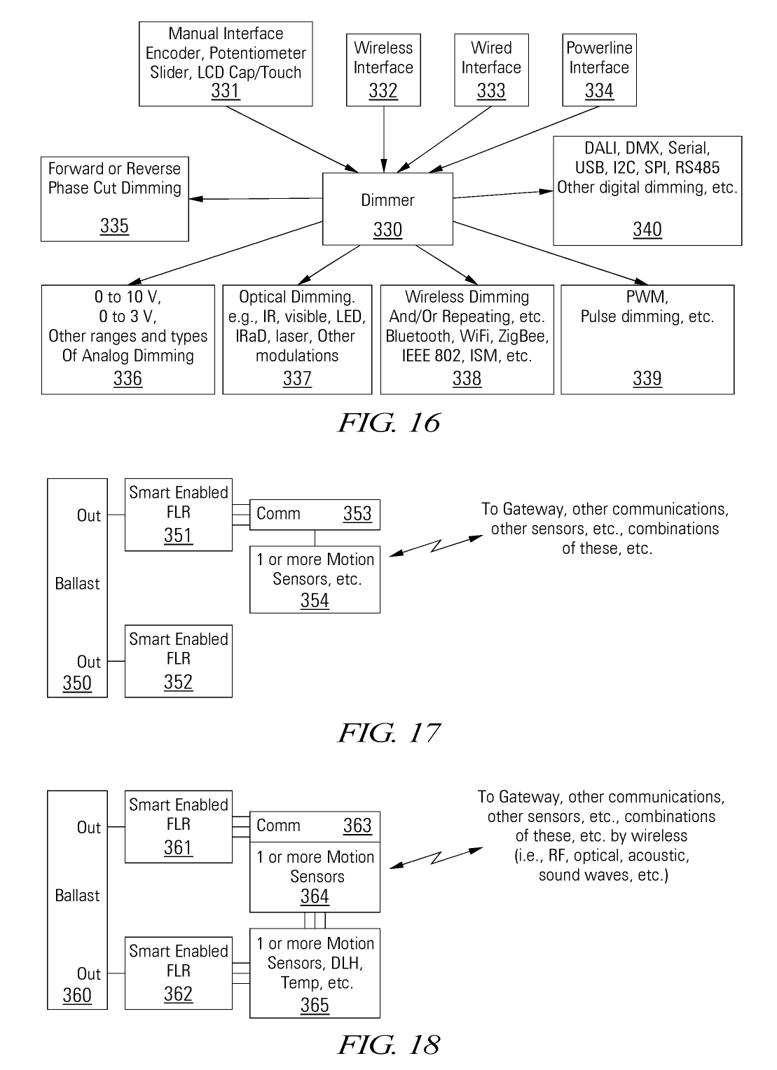

Embodiments of the on/off dimming implementations of the present invention can provide more than one way to turn on/off and/or dim including but not limited to 0 to 3 V, 0 to 10 V, 1 to 8 V, other voltage ranges, as well as providing forward or reverse phase cut dimming which can be selected including but not limited to manually, automatically, programmed, decision making, etc., powerline control in addition to one or more wireless (i.e., RF and/or optical, etc.) as well as other digital and/or analog interfaces, controls, etc. A non-limiting example of such a dimmer/switch is shown in FIG. 16. A dimmer circuit 330 can receive control signals from one or more of a variety of dimming interfaces, such as, but not limited to, manual interfaces 331, wired interfaces 332, wireless interfaces 333, powerline interfaces 334, etc., and can generate and send corresponding dimming commands or control signals to one or more fluorescent lamp replacements or other receivers by one or more of a variety of output interfaces, such as, but not limited to, forward or reverse phase cut dimming 335, 0 to 10 v, 0 to 3 v, other ranges and types of analog dimming 336, optical dimming e.g., IR, visible, LED, IrAD, laser, other modulations 337, wireless dimming and/or repeating, etc. Bluetooth, WiFi, 6LoWPAN, ZigBee, IEEE 802 including but not limited to 802.15.4, ISM, other IEE 80X etc. 338, PWM, pulse dimming, etc. 339, DALI, DMX, serial, USB, I2C, SPI, RS485, POE, and other digital dimming, etc. 340 including but not limited to those discussed elsewhere in this document. The dimmer/switch can also use and/or be powered by POE and/or use the POE for communications.

The present invention can have one or more integrated motion sensors of any type or operation as part of the housing and can also use auxiliary motion sensors and can also have integrated light/photocell sensor as well as auxiliary sensors, power, transmitters, etc.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, including but not limited to, Bluetooth, RFID, WiFi, ZigBee, ZWave, LiFi, 6LoWPAN, Thread, IEEE 801, IEEE 802, ISM, etc. In addition the present invention can be connected to fire alarms, fire alarm, smoke detectors, thermostats, power management, home management and control, monitoring equipment, etc.

The present invention can use a BACNET or other network to wireless converter box or BACNET to Bluetooth including Bluetooth low energy (BLE) converter. The present invention can also use infrared signals to control and dim the lighting and other systems.

The present invention can have the motion and/or proximity sensor(s) send signals back to the controller/monitor or other devices including but not limited to cell phones, smart phones, tablets, computers, laptops, servers, remote controls, etc. when motion or proximity is detected etc. Embodiments of the present invention can have on/off switches, connectors, contactors, circuit breakers, etc. for the ballasts where the ballasts connect to the AC lines and/or also where the ballasts connect to the present invention, etc.

Embodiments and implementations of the present invention allow for optional add-ons including but not limited to wired, wireless or powerline control to be added later and interfaced to the present invention as well as allowing sensors such as daylight harvesting/photo/light/solar/motion/sound/voice/voice recognition/etc. sensors, other sensors, technologies, techniques, detectors, etc. sensors as well as motion/passive infrared-pyroelectric infrared (PIR)/proximity/other types of motion, distance, proximity, location, etc., sensors, detectors, technologies, etc., combinations of these, etc. to be used with the present invention.

Examples of adding smart control and monitoring include having wires or connectors that allow the connection of any or all of the sensors, detectors, techniques, technologies, etc. discussed herein.

The schematics shown are intended to be representative only and in no way or form limiting. For example, in some embodiments the switching/storage inductor or inductors in the buck circuit may be placed in a different position relative to other components.

Embodiments of the present invention could use infrared (IR) to control and monitor including for remote sensing and remote monitoring, remote communications, etc., combinations of these, etc.

Embodiments of the present invention can also use detection of problem or, for example, but not limited to an unauthorized entry or attack including a cyber-attack or hack(ing) via commands at wrong times; for example, if a light is commanded to turn on even though no one is in the building, it is not normal business hours, no motion or other sensors have been activated, etc., combinations of these, etc.

The sensor remote can use IR or other potentially direct detect techniques, technologies, approaches with more than one transmit (and, also, in some embodiments, more than one receive) such that all or one or more of the transmitters fire (turn-on) in a sequence.

In addition, the IR transmitters can also be used to control other devices, for example, but not limited to, televisions, projectors, other audio-visual equipment, radios, stereos, public address systems, air conditioners, heaters, fans, entertainment equipment, etc. such as those disclosed in PCT patent application Ser. No. 13/674,072, filed Jan. 26, 2015 by Sadwick et al. for “Solid State Lighting Systems”, which is incorporated herein for all purposes. Embodiments of the present invention can also use lamps of other form factors including but not limited to A-lamps, PAR lamps, R lamps, MR-lamps, GU-lamps, any type of E26 or E27 lamp socket, etc. where the three pin analog+power or multi-pin digital+power implementation of the present invention is used. Embodiments of the present invention including for linear or other fluorescent lamp replacements can also use USB, other UARTs, POE, etc. to provide power to the sensors, communications, and other IOT devices.

Implementations of the present invention could use other wireless technologies including optical (such as but not limited to LiFi) or RF such as Bluetooth, WiFi, Bluetooth Low Energy, ZigBee, 6LoWPAN, ZWave, etc.

Examples of self-commissioning, commissioning, etc. for the present invention include but are not limited to:
Near field communications (NFC) with geo-locator including but not limited to GPS.
NFC with room map—click and drag to room map as a non-limiting example.
NFC with 2 or 3 dimensional room dimensional system ((for example but not limited to being laser or camera based)
RF Signal strength locator of nearest neighbors in a room
RFID with the same as above for NFC.
Bluetooth with the same as NFC except that the Bluetooth would be powered by a battery or batteries, temporary AC to DC self-commissioning, etc. Could, for example, but not limited to, write to a non-volatile memory location the information about the address and location of the module, etc.
6LoWPAN with the same as NFC except that the 6LowPAN would be powered by a battery or batteries, temporary AC to DC, etc. Could, for example, but not limited to, write to a non-volatile memory location the information about the address and location of the module, etc.
ZigBee with the same as NFC except that the ZigBee would be powered by a battery or batteries, temporary AC to DC, etc. Could, for example, but not limited to, write to a non-volatile memory location the information about the address and location of the module, etc.
Zwave with the same as NFC except that the ZWave would be powered by a battery or batteries, temporary AC to DC, etc. Could, for example, but not limited to, write to a non-volatile memory location the information about the address and location of the module, etc.
LoRa with the same as NFC except that the LoRa would be powered by a battery or batteries, temporary AC to DC, etc. Could, for example, but not limited to, write to a non-volatile memory location the information about the address and location of the module, etc.
WiFi with the same as NFC except that the WiFi would be powered by a battery or batteries, temporary AC to DC, etc. Could, for example, but not limited to, write to a non-volatile memory location the information about the address and location of the module, etc.
Other wireless with the same as NFC except that the wireless would be powered by a battery or batteries, temporary AC to DC, etc. Could, for example, but not limited to, write to a non-volatile memory location the information about the address and location of the module, etc.
Wired with the essentially same as NFC except that the wired would be powered by a battery or batteries, temporary AC to DC, etc. Could, for example, but not limited to, write to a non-volatile memory location the information about the address and location of the module, etc.
QR codes or barcodes read before the external sensor and communication modules are inserted into/connected to the power source of the present invention.
Spatial recognition of the location. Artificial Intelligence recognition of the light fixture. Vision recognition of the light fixture. Camera, vision use/recognition, mapping, etc.
Powering of the sensor/communication module using a battery or an AC to DC adaptor and setting the settings for the module before inserting/connecting to the present invention.
Setting DIP switches to determine the address
Assigning addresses by time of flight with the nearest ones getting the first addresses and calculating which are the nearest, based on but not limited to, geometry.

Some embodiments of the solid state lighting system use localized sensors attached to the smart enabled fluorescent lamp replacements and/or communications circuits (e.g., 353) depicted in FIGS. 17-26 to provide information and data and communicate with the Gateway or one or more lead units. Such communication can be, for example, for detection of motion using, but not limited to, sound, ultrasonic waves, phase lock loops, two tone generators, kHz and above oscillators, RF, microwave, IR, IrDA (Infrared Data Association) including pulse code modulation (PCM), pulse distance coding (PDC), pulse length coding (PLC), Manchester coding, other IR communications, other communications, etc., combinations of these, etc. that can be either or both analog and/or digital including but not limited to phase lock loops (PLLs), voltage controlled oscillators (VCOs), voltage to frequency converters (VFCs), negative feedback oscillators, digital signal processors (DSPs), microcontrollers, microprocessors, FPGAs, PLCs, etc., filters, including both analog and digital filters, etc. As one example, a microcontroller can be used with or without a filter to produce an output signal at a particular frequency or frequencies with or without modulation(s). Embodiments of the present invention can also use/include LiFi for communications including but not limited to between the sensors and the lights, between the lights and the Gateway, between the sensors and the Gateway(s), between the various sensors, etc., combinations of these, etc.

Turning to FIG. 17, a solid state lighting system is depicted with multiple fluorescent lamp replacements, multiple localized sensors and communications to a Gateway that can coordinate control and data collection with other solid state lighting systems or other devices. Smart-enabled fluorescent lamp replacements 351, 352 are configured with one or more of the capabilities set forth herein, such as, but not limited to, dimming, color control and changing, flashing, scheduling, control in response to sensor input, reporting, etc. The smart-enabled fluorescent lamp replacements 351, 352 are powered by the outputs of a ballast 350 of any type in a fluorescent lamp fixture, or by an AC line through a fluorescent lamp fixture without a ballast, or from any other suitable source. A communications circuit 353 is powered by a power output from a fluorescent lamp replacement 351 and interfaces with the fluorescent lamp replacement 351, for example sending dimming commands, color commands, etc. to the fluorescent lamp replacement 351, receiving feedback or status information from the fluorescent lamp replacement 351, etc. The communications circuit 353 can also receive input from one or more motion sensors, etc. 354 for use in controlling the fluorescent lamp replacement 351 or more than one fluorescent lamp replacements (i.e., groups or zones of fluorescent lamp replacements). The communications circuit 353 can also communicate with a Gateway using any wired or wireless connection or network, including using multiple types of communication. Embodiments can also support additional sensors, communications, Internet of Things (JOT), combinations of these, etc.

Turning to FIG. 18, another example embodiment of a solid state lighting system is depicted with multiple fluorescent lamp replacements 361, 362 powered by a ballast 360. The fluorescent lamp replacements 361, 362 are configured to power and receive input from multiple localized sensors, daylight harvesters (DLH), temperature sensors, motion detectors, position sensors, IR detectors, other IOT devices, etc. 364, 365, which can also be interconnected to pass power and data signals as needed or desired. A communications circuit 353 is also powered by and connected to one or more of the fluorescent lamp replacements (e.g., 361) in any suitable manner and can communicate with a Gateway that can coordinate control and data collection with other solid state lighting systems or other devices.

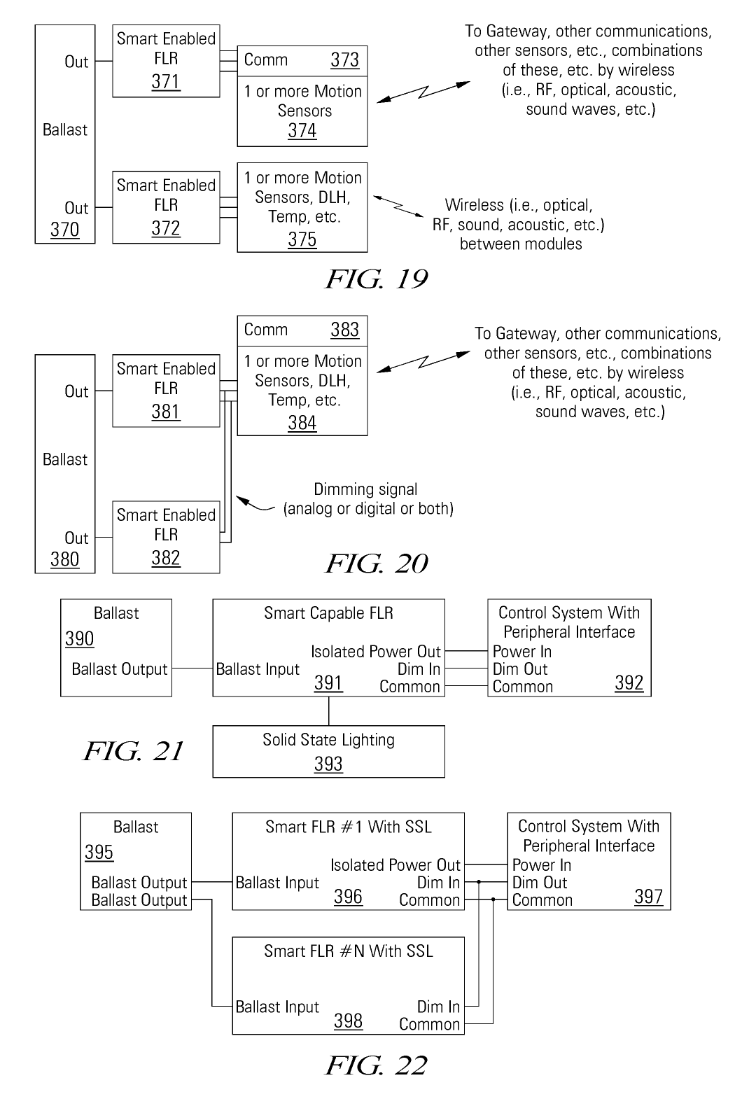

Turning to FIG. 19, another example embodiment of a solid state lighting system is depicted with multiple fluorescent lamp replacements 371, 372 powered by a ballast 370. The fluorescent lamp replacements 371, 372 are configured to power and receive input from multiple localized sensors, daylight harvesters (DLH), temperature sensors, motion detectors, position sensors, IR detectors, etc. 374, 375, which can also be interconnected to pass power and data signals as needed or desired. A communications circuit 373 is also powered by and connected to one or more of the fluorescent lamp replacements (e.g., 371) in any suitable manner and can communicate with a Gateway that can coordinate control and data collection with other solid state lighting systems or other devices.

Turning to FIG. 20, another example embodiment of a solid state lighting system is depicted with multiple fluorescent lamp replacements 381, 382 powered by a ballast 380. The fluorescent lamp replacements 381, 382 are configured to power and receive input from localized sensors, one or more daylight harvester(s) (DLH), temperature sensors, motion detectors, position sensors, IR detectors, etc. 384, which can also be interconnected to pass power and data signals as needed or desired. A communications circuit 383 is also powered by and connected to one or more of the fluorescent lamp replacements (e.g., 381) via one or more of the sensors 384 in any suitable manner and can communicate with a Gateway that can coordinate control and data collection with other solid state lighting systems or other devices. The fluorescent lamp replacements 381, 382 can be interconnected by one or more dimming signals of any type, including analog or digital or both, wired or wireless, etc.

Turning to FIG. 21, an example embodiment of a solid state lighting system is depicted with a smart capable fluorescent lamp replacement 391 powering a solid state light 393 such as, but not limited to, one or more LEDs, OLEDs, and/or QDs or arrays of these or other loads from the output of a ballast 390 in a fluorescent lamp fixture, or from the AC line in a fluorescent lamp fixture. The smart capable fluorescent lamp replacement 391 provides an isolated power output to a control system 392 with a peripheral interface, with a linking common signal in some embodiments, and receives one or more dimming control signals in any suitable format and manner. Such a peripheral interface can comprise wired or wireless communication in any format or in multiple formats. The peripheral interface can include or can communicate with sensors including but not limited to motion, sound, light, temperature, daylight, passive infrared-pyroelectric infrared (PIR), ultrasonic, sonar, radar, voice, gesture, etc. Such peripherals can be powered by an isolated power signal from the smart capable fluorescent lamp replacement 391, derived from the output of the ballast 390. Such peripherals can be replaced, removed, augmented etc. without changing the smart capable fluorescent lamp replacement 391. Wired connections can include but are not limited to analog, digital, both, PWM, other types of modulation(s), all, combinations, etc. Wireless connections can include but are not limited to analog, digital, both, PWM, other types of modulation(s), all, combinations, etc. including but not limited to quadrature, phase, amplitude, etc., combinations of these, etc. using optical including but not limited to infrared (IR), radio frequency (RF) including but not limited to sub-GHz, 2.4 GHz, below 1 kHz to above 1 GHz, to above 1 THz, to optical, etc., combinations of these, etc. Embodiments of the present invention can control one or more fluorescent lamp replacements, groups of fluorescent lamp replacements, other types and form factors of lights, lamps, luminaires, etc., combinations of these, etc.

Turning to FIG. 22, an example embodiment of a solid state lighting system is depicted with multiple smart capable fluorescent lamp replacements 396, 398 which can include or which can power a solid state light as, but not limited to, one or more LEDs, OLEDs, and/or QDs or arrays of these or other loads, powering them from the output of a ballast 395 in a fluorescent lamp fixture, or from the AC line in a fluorescent lamp fixture. One or more of the smart capable fluorescent lamp replacements (e.g., 396) provides an isolated power output to other smart capable fluorescent lamp replacements (e.g., 398) and to a control system 397 with a peripheral interface. Such a peripheral interface can comprise wired or wireless communication in any format or in multiple formats. The peripheral interface can include or can communicate with sensors including but not limited to motion, sound, light, temperature, daylight, PIR, ultrasonic, sonar, radar, voice, gesture, etc., can include other devices such as, but not limited to, speakers, sirens, alarms, alerts, cameras, etc., and can power the peripherals from the isolated power output from the fluorescent lamp replacement 396. Embodiments of the present invention can control one or more fluorescent lamp replacements, groups of fluorescent lamp replacements, other types and form factors of lights, lamps, luminaires, etc., combinations of these, etc.

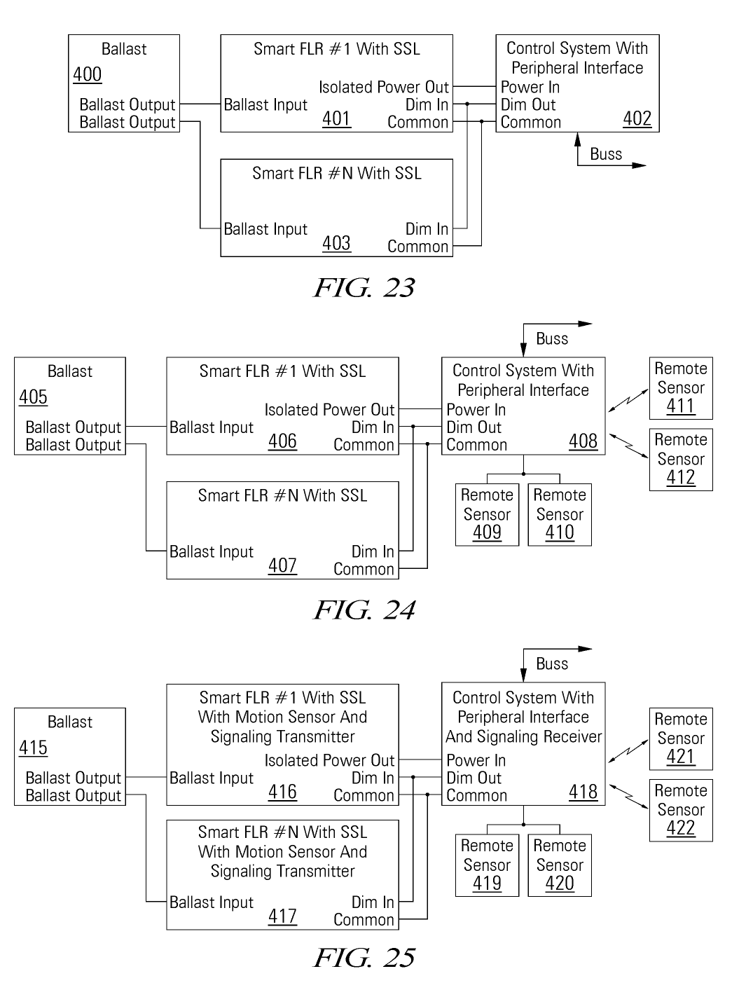

Turning to FIG. 23, an example embodiment of a solid state lighting system is depicted with multiple smart capable fluorescent lamp replacements 401, 403 which can include or which can power a solid state light as, but not limited to, one or more LEDs, OLEDs, and/or QDs or arrays of these or other loads, powering them from the output of a ballast 400 in a fluorescent lamp fixture, or from the AC line in a fluorescent lamp fixture. One or more of the smart capable fluorescent lamp replacements (e.g., 401) provides an isolated power output to other smart capable fluorescent lamp replacements (e.g., 403) and to a control system 402 with a peripheral interface. Such a peripheral interface can comprise wired or wireless communication in any format or in multiple formats. The peripheral interface can include or can communicate with sensors including but not limited to motion, sound, light, temperature, daylight, PIR, ultrasonic, sonar, radar, voice, gesture, etc., can include other devices such as, but not limited to, speakers, sirens, alarms, alerts, cameras, etc., and can power the peripherals from the isolated power output from the fluorescent lamp replacement 401. The control system with peripheral interface 402 can communicate with other control systems or devices via one or more communications busses of any type. Embodiments of the present invention can control one or more fluorescent lamp replacements, groups of fluorescent lamp replacements, other types and form factors of lights, lamps, luminaires, etc., combinations of these, etc.

Turning to FIG. 24, an example embodiment of a solid state lighting system is depicted with multiple smart capable fluorescent lamp replacements 406, 407 which can include or which can power a solid state light as, but not limited to, one or more LEDs, OLEDs, and/or QDs or arrays of these or other loads, powering them from the output of a ballast 405 in a fluorescent lamp fixture, or from the AC line in a fluorescent lamp fixture. One or more of the smart capable fluorescent lamp replacements (e.g., 406) provides an isolated power output to other smart capable fluorescent lamp replacements (e.g., 407) and to a control system 408 with a peripheral interface. The peripheral interface can communicate with sensors 409, 410, 411, 412 including but not limited to motion, sound, light, temperature, daylight, PIR, ultrasonic, sonar, radar, voice, gesture, etc., can include other devices such as, but not limited to, speakers, sirens, alarms, alerts, cameras, etc., and can power the peripherals from the isolated power output from the fluorescent lamp replacement 406. The sensors can be connected using wired or wireless communication. The control system with peripheral interface 408 can communicate with other control systems or devices via one or more communications busses of any type. Embodiments of the present invention can control one or more fluorescent lamp replacements, groups of fluorescent lamp replacements, other types and form factors of lights, lamps, luminaires, etc., combinations of these, etc.

Turning to FIG. 25, an example embodiment of a solid state lighting system is depicted with multiple smart capable fluorescent lamp replacements 416, 417 which can include or which can power a solid state light as, but not limited to, one or more LEDs, OLEDs, and/or QDs or arrays of these or other loads, powering them from the output of a ballast 415 in a fluorescent lamp fixture, or from the AC line in a fluorescent lamp fixture. The smart capable fluorescent lamp replacements 416, 417 can include sensors such as, but not limited to, motion sensors, and a signaling transmitter to communicate the sensor output to a signaling receiver in a control system 418 with a peripheral interface using the signaling transmitter. For example, in some embodiments, the signaling transmitters comprise sound generators or speakers that output a sound at a particular frequency, or can use an IR signal or an RF signal, etc. that indicate that a motion sensor has detected movement. The control system 418 can then control one or more of the smart capable fluorescent lamp replacements 416, 417 to turn on lights, change the dimming level, change light color, or take any other appropriate action in response to the detected motion, even in systems in which the signaling transmitters in the smart capable fluorescent lamp replacements 416, 417 are not differentiated. However, in some embodiments, the signaling transmitters produce differentiated and identifiable signals. Embodiments of the present invention can control one or more fluorescent lamp replacements, groups of fluorescent lamp replacements, other types and form factors of lights, lamps, luminaires, etc., combinations of these, etc.

One or more of the smart capable fluorescent lamp replacements (e.g., 416) provides an isolated power output to other smart capable fluorescent lamp replacements (e.g., 417) and to the control system 418 with a peripheral interface. The peripheral interface can communicate with sensors 419, 420, 421, 422 including but not limited to motion, sound, light, temperature, daylight, PIR, ultrasonic, sonar, radar, voice, gesture, etc., can include other devices such as, but not limited to, speakers, sirens, alarms, alerts, cameras, etc., and can power the peripherals from the isolated power output from the fluorescent lamp replacement 406. The sensors can be connected using wired or wireless communication. The control system with peripheral interface 418 can communicate with other control systems or devices via one or more communications busses of any type. Embodiments of the present invention can control one or more fluorescent lamp replacements, groups of fluorescent lamp replacements, other types and form factors of lights, lamps, luminaires, etc., combinations of these, etc.

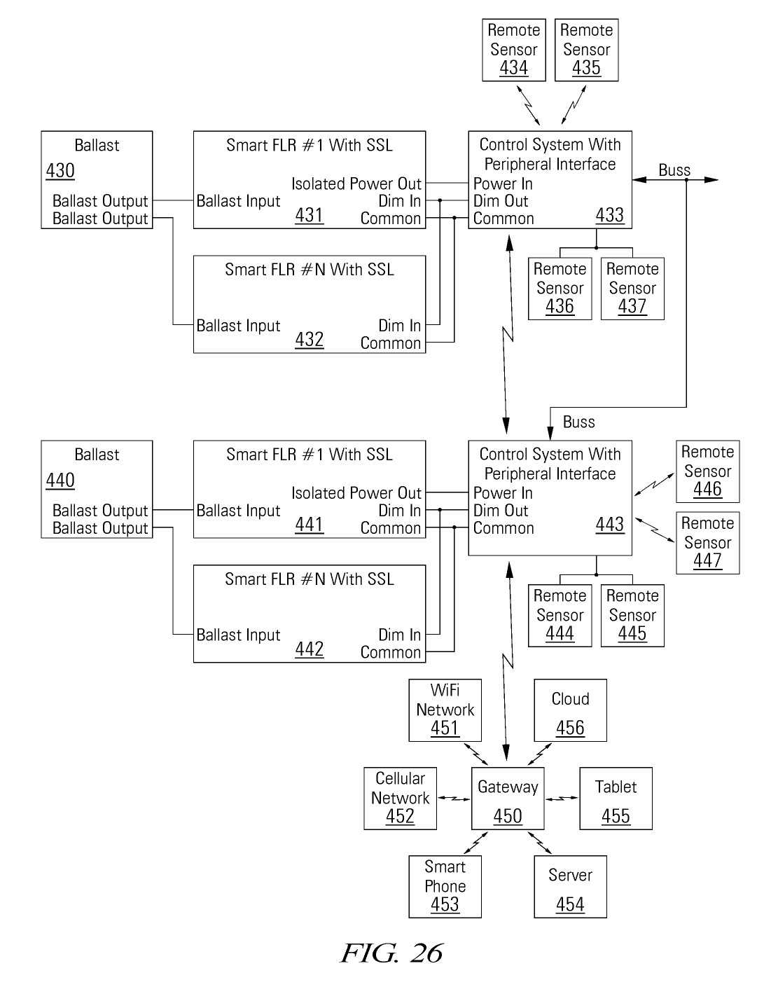

Turning to FIG. 26, a solid state lighting system is depicted which includes multiple fluorescent lamp fixtures, including multiple smart capable fluorescent lamp replacements, control systems, multiple remote sensors, buss connection and gateway in accordance with some embodiments of the invention.

Multiple smart capable fluorescent lamp replacements 431, 432 draw power from a ballast output from the ballast 430 or AC line in a first fluorescent lamp fixture or be selectable including automatically selectable from a ballast to AC lines should the ballast fail or cease to operate properly. One or more of the smart capable fluorescent lamp replacements (e.g., 431) provides an isolated power output to components including but not limited to a control system 433 with a peripheral interface. The peripheral interface can communicate with remote sensors (e.g., 434, 435, 436, 437) including but not limited to motion, sound, light, temperature, daylight, PIR, ultrasonic, sonar, radar, voice, gesture, etc., and other devices such as, but not limited to, speakers, sirens, alarms, alerts, cameras, etc., and can power the peripherals from the isolated power output from the fluorescent lamp replacement 431. The sensors can be connected using wired or wireless communication. The control system with peripheral interface 433 can communicate with other control systems or devices via one or more communications busses of any type.

Multiple smart capable fluorescent lamp replacements 441, 442 draw power from a ballast output from the ballast 440 or AC line in another fluorescent lamp fixture. One or more of the smart capable fluorescent lamp replacements (e.g., 441) provides an isolated power output to other smart capable fluorescent lamp replacements (e.g., 442) and to a control system 443 with a peripheral interface. The peripheral interface can communicate with remote sensors (e.g., 444, 445, 446, 447) including but not limited to motion, sound, light, temperature, daylight, PIR, ultrasonic, sonar, radar, voice, gesture, etc., and other devices such as, but not limited to, speakers, sirens, alarms, alerts, cameras, etc., and can power the peripherals from the isolated power output from the fluorescent lamp replacement 441. The sensors can be connected using wired or wireless communication. The control system with peripheral interface 443 can communicate with other control systems or devices via one or more communications busses of any type, as well as with other control systems (e.g., 433). Embodiments of the present invention can control one or more fluorescent lamp replacements, groups of fluorescent lamp replacements, other types and form factors of lights, lamps, luminaires, etc., combinations of these, etc. including ones that just have a dimming input and no other intelligence in the lamp itself.

The control systems 433, 443 can also communicate with one or more gateways (e.g., 450), or aggregators, accumulators, servers, loggers, etc. that can communicate among the fluorescent lamp replacements (e.g., 431, 432, 441, 442), the sensors (434, 435, 436, 437, 444, 445, 446, 447), themselves, to other servers including but not limited to a central server 454, a laptop, a desktop, other devices including but not limited to smart phones 453, tablets 455, personal digital assistants, mobile carriers 452, cloud-based systems 456, WiFi networks 451, etc.

Based upon the disclosure herein, one of skill in the art will recognize that any number or combination of smart fluorescent lamp replacements in any variation can be networked or connected with control systems, gateways, remote sensors, peripherals, networks, etc. in an endless variety of configurations based upon the application and requirements. This includes having more than one smart lamp, one of more follower lamps that accept a dimming signal (which could be analog, digital or both or of any other type) and respond accordingly.

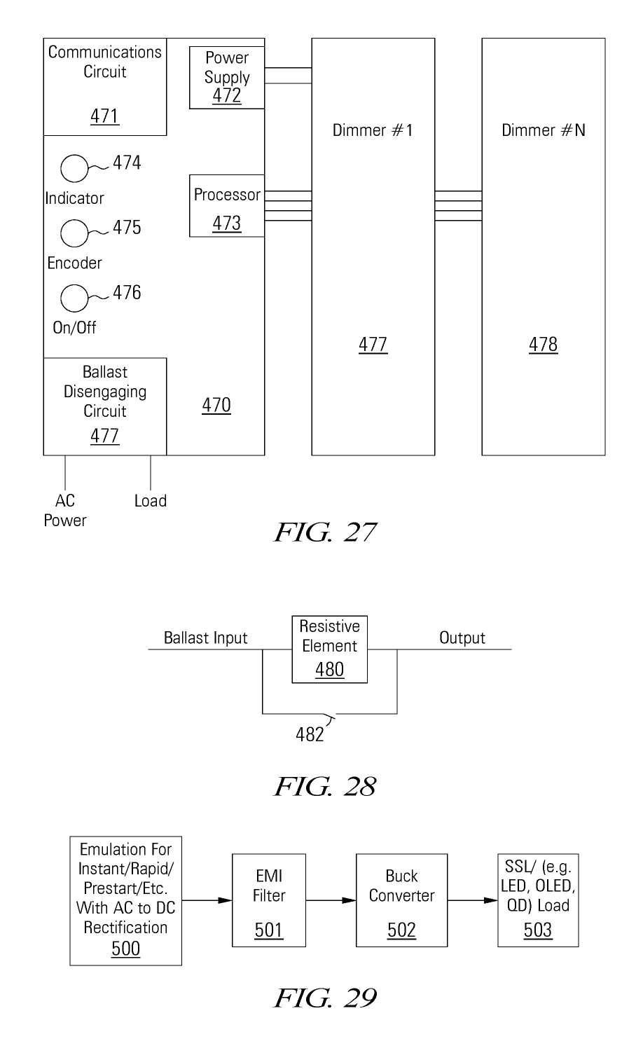

While portable remote control devices such as cellphones, etc., can be extremely convenient for communicating with and controlling solid state lighting systems, wall switches can also increase usability in some embodiments. Turning to FIG. 27, an example wall switch 470 is depicted connected to multiple dimmers 477, 478 in accordance with some embodiments of the invention. Such a wall switch 470 includes a communications circuit 471 to communicate with one or more dimmers 477, 478 or other gateways, systems, etc. The wall switch 470 can also include a power supply 472 to power the dimmers 477, 478 in addition, for example but not limited to, to other peripherals, sensors, IOT devices, etc. The wall switch 470 can include any suitable interface, such as, but not limited to, an on/off control 476 and dimming encoder 475, each of which can be implemented in any suitable fashion such as, but not limited to a button, slider, rotary encoder, switch, toggle, touch screen control, gesture, proximity, IR proximity, ultrasonic proximity, radar proximity, sonar proximity, capacitive proximity, other proximity sensors, capacitance sensing, voice recognition input, etc. One or more indicators 474 or displays can be provided to indicate power status, lighting status, color, mode, scheduling, scenes, sequencing, etc. Embodiments such as those of FIG. 27 can also use and be powered by POE.

A processor 473 such as, but not limited to, a microcontroller or any other type of similar device including any other device discussed herein can generate dimming commands, process inputs, generate outputs, accept sensor inputs, status feedback, etc. with the dimmers 477, 478 and other devices.

The wall switch 470 can receive AC power from an AC line, can provide suitable power to a load, and can also include a ballast disengaging circuit 477 to fully disengage or turn off power input from a ballast in a fluorescent lamp fixture when a dimming level is set to a low or minimum level, thereby preventing power draw from the ballast when the lights are dimmed to a lowest level or an off level. Embodiments of the wall switch can use analog, digital, combinations of both, etc. to send, receive, control, monitor, log, etc. Embodiments of the present invention can also monitor voltage, current, power, etc. consumption and usage as well as other power conditions including but not limited to power factor, harmonic distortion, total harmonic distortion, etc. Embodiments of the wall switch may also have sensors including but not limited to motion, IR, PIR, radar, sonar, ultrasonics, sound, voice recognition, biometrics, fingerprint detection, eye detection, mood detection, gesture detection, etc., other IOT devices, sensors, controls, etc., combinations of these, etc.

Some embodiments of the present invention include inrush current limiting in any form such that the ballast does not experience or result in an inrush current when power is first applied. A simple block diagram example of such a current limiter is shown in FIG. 28, wherein a resistive element 480 is connected to the ballast input to limit inrush current when power is first applied, and wherein a switch 482 bypasses or disables the resistive element 480 after power is first applied and after an expected inrush period has passed, thereby effectively removing the resistive element 480 for normal operation. Such an inrush current limiter can be consist of any known technology, approach, topology, etc. and can include but is not limited to, one or more of inrush limiters, thermistors, solid state devices, semiconductor devices, capacitors, inductors, capacitive elements, inductive elements, reactive elements, components, etc., vacuum tubes, combinations of these, etc.

Turning to FIG. 29, a block diagram of a solid state lighting system is depicted that can be powered by both AC lines and ballast outputs, and that can be remotely controlled and dimmed in both modes. An emulation circuit 500 can be included to emulate a fluorescent or HID tube for instant/rapid/prestart ballasts to enable or assist the ballast to operate normally when the fluorescent or HID tube has been replaced, as well as to provide AC to DC rectification. An EMI filter 501 can be included to reduce EMI. A buck converter 502 converts the input power to the power signal required for the LED, OLED, QD and/or combinations of these and/or other loads 503. Although a buck circuit can be used for power conversion, as an example, most any other type of switching circuit such as, but not limited to, a buck-boost, boost, boost-buck, Cuk, SEPIC, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit.

The buck converter can have OVP, OTP, OCP, shock hazard/pin safety protection, constant current, etc. Normally on (NO) and normally closed (NC) switches that are, for example single or double (or higher) and single (or higher) pole can be used.

The present invention can be used with AC line voltage including but not limited to 80 to 305 VAC 50/60 Hz, 347 VAC 50/60 Hz, 480 VAC 50/60 Hz other 50/60 Hz voltages, magnetic and electronic ballasts, low frequency and high frequency ballasts, instant start, rapid start, programmed start, program start, pre-start, warm, cold, hot types of ballasts, etc. In some embodiments a switch, including a mechanical, electromechanical, semiconductor, solid state, relay, etc., of any types and forms, etc., combinations, etc. can be used to connect and control power to the present invention.

Turning to FIG. 30, a block diagram of a solid state lighting system is depicted that can be powered by both AC lines and ballast outputs, and that can be remotely controlled and dimmed in both modes. An emulation circuit 505 can be included to emulate a fluorescent or HID tube for instant/rapid/prestart ballasts to enable or assist the ballast to operate normally when the fluorescent or HID tube has been replaced, as well as to provide AC to DC rectification. An EMI filter 506 can be included to reduce EMI. A buck converter 507 converts the input power to the power signal required for the LED, OLED, QD and/or combinations of these and/or other loads 508. Although a buck circuit can be used for power conversion, as an example, most any other type of switching circuit such as, but not limited to, a buck-boost, boost, boost-buck, Cuk, SEPIC, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 509 can be received and processed to control the current and/or voltage to the load 508, such as, but not limited to, optional wall (Triac), 0 to 3 VDC, 0 to 10 VDC, powerline (PLC), wireless, DMX, RS485, RS232, SPI, I2C, RS 422, UART, CAN bus, Ethernet, Profibus, Modbus, etc., other serial and parallel standards and interfaces and/or DALI dimming as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc., others discussed herein, combinations of these, etc.

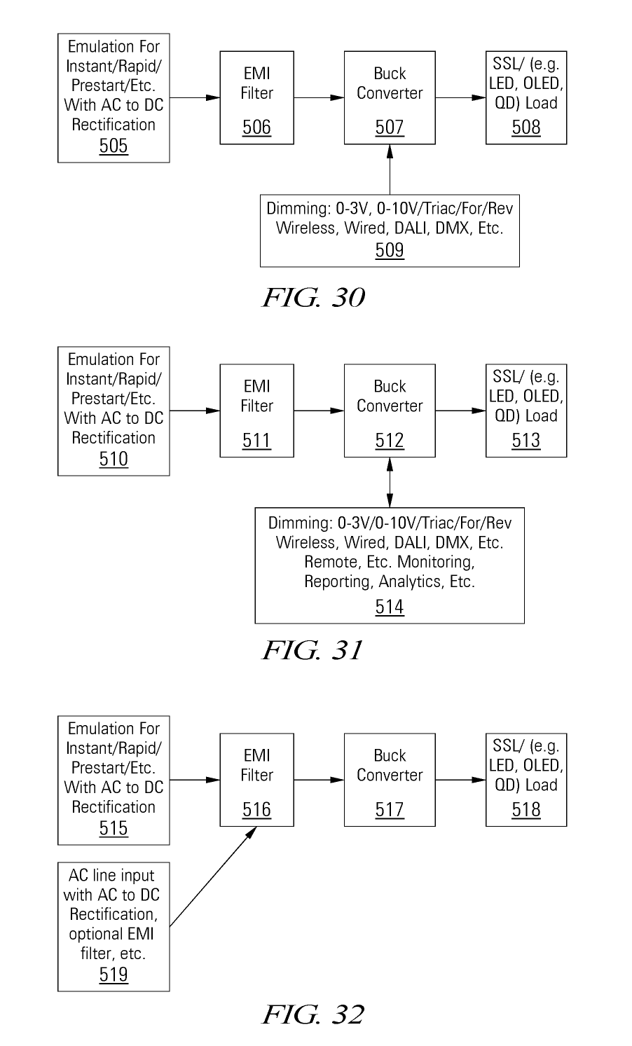

Turning to FIG. 31, a block diagram of a solid state lighting system is depicted that can be powered by both AC lines and ballast outputs, and that can be remotely controlled and dimmed in both modes. An emulation circuit 510 can be included to emulate a fluorescent or HID tube for instant/rapid/prestart ballasts to enable or assist the ballast to operate normally when the fluorescent or HID tube has been replaced, as well as to provide AC to DC rectification. An EMI filter 511 can be included to reduce EMI. A buck converter 512 converts the input power to the power signal required for the LED, OLED, QD and/or combinations of these and/or other loads 513. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 514 can be received and processed to control the current and/or voltage to the load 513, such as, but not limited to, optional wall (Triac), 0 to 3 VDC, 0 to 10 VDC, powerline (PLC), wireless, DMX, RS485, RS232, SPI, I2C, RS 422, UART, CAN bus, Ethernet, Profibus, Modbus, etc., other serial and parallel standards and interfaces and/or DALI dimming as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc., others discussed herein, etc. The control signal 514 can also support remote and/or local monitoring, reporting, analytics, etc.

Turning to FIG. 32, a block diagram of a solid state lighting system is depicted that can be powered by both AC lines and ballast outputs, and that can be remotely controlled and dimmed in both modes. An emulation circuit 515 can be included to emulate a fluorescent or HID tube for instant/rapid/prestart ballasts to enable or assist the ballast to operate normally when the fluorescent or HID tube has been replaced, as well as to provide AC to DC rectification. An EMI filter 516 can be included to reduce EMI. A buck converter 517 converts the input power to the power signal required for the LED, OLED, QD and/or combinations of these and/or other loads 518. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. An AC line input 519 with AC to DC rectification and optional EMI filter, etc. provides power to the solid state lighting system in the absence of a ballast in the fluorescent lamp fixture.

Notably, all embodiments of the solid state lighting system can be adapted for use with multiple power sources including, but not limited to, the output of a ballast in a fluorescent lamp fixture and an AC line which may be accessed in some embodiments through a fluorescent lamp fixture. The omission of any inventive feature of the solid state lighting system from an example embodiment disclosed herein or depicted in the Figures should not be interpreted as an indication that the embodiment cannot include the feature, or that the invention is limited to the specific depictions in the Figures. For example, the embodiments of FIGS. 17-26 and others, though they are not depicted with AC line inputs, can be configured to accept power both from an output of a ballast and from an AC line input as disclosed elsewhere herein, such as in the embodiment of FIG. 9. Again, the embodiments disclosed and depicted in the Figures are non-limiting examples intended to depict example features which can be combined in any number of fashions depending on the application and requirements.

Furthermore, the embodiments of FIGS. 17-26, in which smart fluorescent lamp replacements provide an isolated power output to remote sensors, communications, control, IOT devices in general via a control system with peripheral interface, can include lighting power supplies such as, but not limited to, the buck converters etc. depicted in the embodiments of FIGS. 30-37, and of course the inverse is also true. Thus, any particular embodiment can include the isolated power generation, the solid state lighting power generation, dimming control, and other features disclosed herein, or any subset of them, in any combination. Embodiments of the solid state lighting systems can include buck converters as shown in the Figures, or buck-boost, boost, boost-buck, Cuk, SEPIC, quasiresonant, Flyback, forward converters, push-pull, current mode, voltage mode, etc. combinations of these, etc. In general, any type of switching/storage power supply can be adapted for use in the solid state lighting systems.

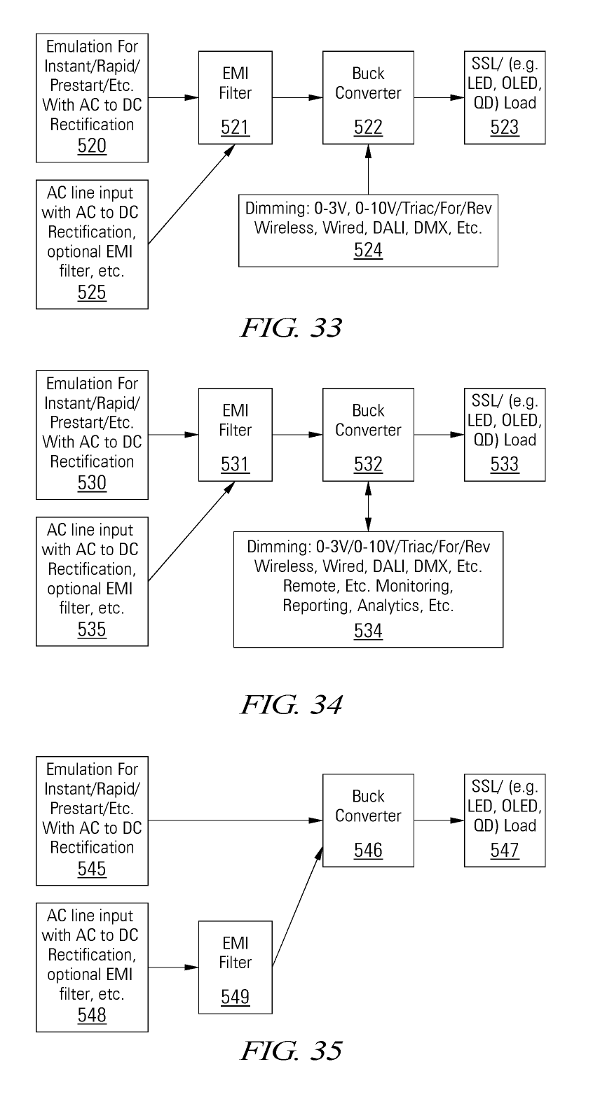

Turning to FIG. 33, a block diagram of a solid state lighting system is depicted that can be powered by both AC lines and ballast outputs, and that can be remotely controlled and dimmed in both modes. An emulation circuit 520 which could for example, but not limited to those depicted in FIG. 1 and FIG. 8 with or without additional components such as resistors, etc. can be included to emulate a fluorescent or HID tube for instant/rapid/prestart ballasts to enable or assist the ballast to operate normally when the fluorescent or HID tube has been replaced, as well as to provide AC to DC rectification. An EMI filter 521 can be included to reduce EMI. A buck converter 522 converts the input power to the power signal required for the LED, OLED, QD and/or combinations of these and/or other loads 523. Although a buck circuit can be used for power conversion, as an example, most any other type of switching circuit such as, but not limited to, a buck-boost, boost, boost-buck, Cuk, SEPIC, quasi-resonant, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 524 can be received and processed to control the current and/or voltage to the load 523, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. An AC line input 525 with AC to DC rectification and optional EMI filter, etc. provides power to the solid state lighting system in the absence of a ballast in the fluorescent lamp fixture.

Turning to FIG. 34, a block diagram of a solid state lighting system is depicted that can be powered by both AC lines and ballast outputs, and that can be remotely controlled and dimmed in both modes. An emulation circuit 530 can be included to emulate a fluorescent or HID tube for instant/rapid/prestart ballasts to enable or assist the ballast to operate normally when the fluorescent or HID tube has been replaced, as well as to provide AC to DC rectification. An EMI filter 531 can be included to reduce EMI. A buck converter 532 converts the input power to the power signal required for the LED, OLED, QD and/or combinations of these and/or other loads 533. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 534 can be received and processed to control the current and/or voltage to the load 533, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 534 can also support remote and/or local monitoring, reporting, analytics, etc. An AC line input 535 with AC to DC rectification and optional EMI filter, etc. provides power to the solid state lighting system in the absence of a ballast in the fluorescent lamp fixture.

Turning to FIG. 35, a block diagram of a solid state lighting system is depicted that can be powered by both AC lines and ballast outputs, and that can be remotely controlled and dimmed in both modes. An emulation circuit 545 can be included to emulate a fluorescent or HID tube for instant/rapid/prestart ballasts to enable or assist the ballast to operate normally when the fluorescent or HID tube has been replaced, as well as to provide AC to DC rectification. A buck converter 546 converts the input power to the power signal required for the LED, OLED, QD and/or combinations of these and/or other loads 547. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. An AC line input 548 with AC to DC rectification and optional EMI filter, etc. provides power to the solid state lighting system in the absence of a ballast in the fluorescent lamp fixture. An EMI filter 549 can be included to reduce EMI.

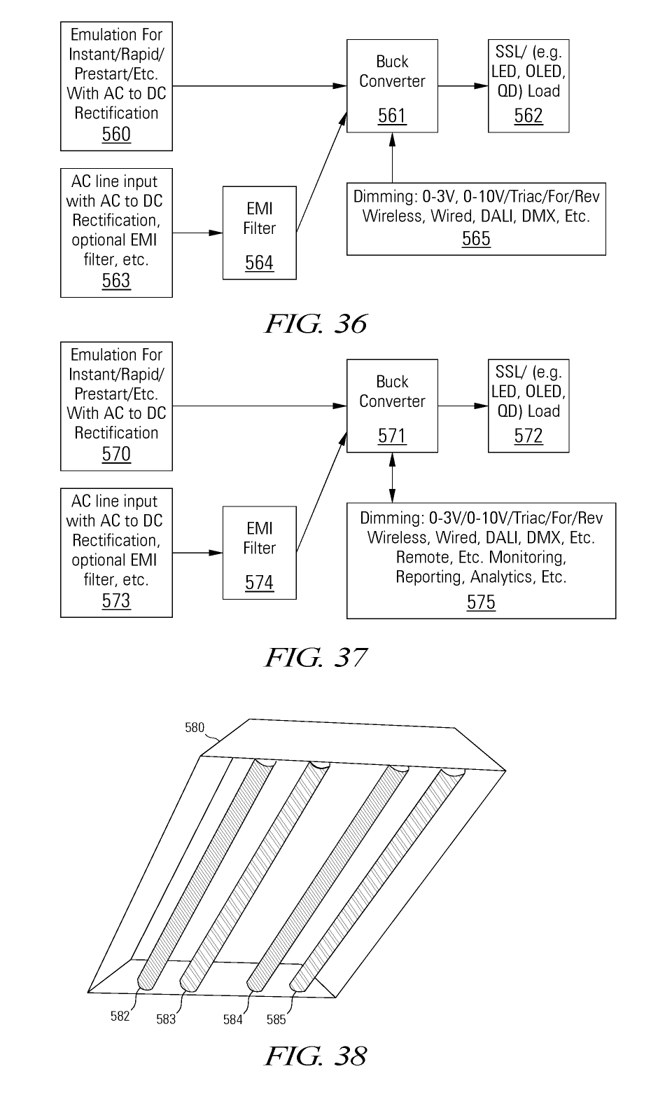

Turning to FIG. 36, a block diagram of a solid state lighting system is depicted that can be powered by both AC lines and ballast outputs, and that can be remotely controlled and dimmed in both modes. An emulation circuit 560 can be included to emulate a fluorescent or HID tube for instant/rapid/prestart ballasts to enable or assist the ballast to operate normally when the fluorescent or HID tube has been replaced, as well as to provide AC to DC rectification. A buck converter 561 converts the input power to the power signal required for the LED, OLED, QD and/or combinations of these and/or other loads 562. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 565 can be received and processed to control the current and/or voltage to the load 562, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. An AC line input 563 with AC to DC rectification and optional EMI filter, etc. provides power to the solid state lighting system in the absence of a ballast in the fluorescent lamp fixture. An EMI filter 564 can be included to reduce EMI.

Turning to FIG. 37, a block diagram of a solid state lighting system is depicted that can be powered by both AC lines and ballast outputs, and that can be remotely controlled and dimmed in both modes. An emulation circuit 570 can be included to emulate a fluorescent or HID tube for instant/rapid/prestart ballasts to enable or assist the ballast to operate normally when the fluorescent or HID tube has been replaced, as well as to provide AC to DC rectification. A buck converter 571 converts the input power to the power signal required for the LED, OLED, QD and/or combinations of these and/or other loads 572. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 575 can be received and processed to control the current and/or voltage to the load 572, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 575 can also support remote and/or local monitoring, reporting, analytics, etc. An AC line input 573 with AC to DC rectification and optional EMI filter, etc. provides power to the solid state lighting system in the absence of a ballast in the fluorescent lamp fixture. An EMI filter 574 can be included to reduce EMI.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc.

Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc.

Embodiments of the present invention can employ cost effective, energy efficient, fully controlled and protected electronics coupled with, for example, high quality, efficient color temperature controlled/maintained SSLs. Adaptive sensors and controls can communicate typically at low data rates with low data content to achieve energy usage reduction for the SSL FLR lighting products. Embodiments of the present invention can also be able to respond to voice commands, gestures, proximity of all types including but not limited to those discussed herein, etc., combinations of these. Smart phones and tablets can be connected in a number of ways with the implementations of the present invention to energy savings sensor systems including BACNET, LONNET, other building automation systems, Bluetooth, Bluetooth Low Energy (BLE), ZigBee, LiFi, WiFi, ISM and other ways without or with the internet or IPs including IPv4 and IPv6 implemented with for example but not limited to 6LoWPAN, Thread.

The power supplies/drivers for the present invention can include compatibility with essentially all or specific dimming protocols such as but not limited to triac/forward/reverse dimmers and all digital dimming protocols; and is compatible with ambient light sensors. The power supplies and drivers for SSL FLRs can convert relatively high frequency (typically 40 to 100 kHz) AC input to DC output power, and are able to support various types of remote control/dimming, meet FCC EMI conducted and radiated limits, provide over-current (OCP), over-voltage (OVP), over-temperature (OTP) and short circuit protection (SCP). Embodiments of the present invention can be ultra-efficient, highly flexible and allow SSL FLRs to support white light, white color tuning and, for example, optional features including color tunable red/green/blue (RGB), RGB and amber (RGBA), more than one white color temperature (i.e., WWRGBA, WWWRGBA, etc.) etc. modes of SSL operation.

Embodiments of the present invention, in addition to being ballast-compatible SSL direct replacement FLRs that work with electronic ballasts including but not limited to, instant-start, rapid-start, etc. ballasts, are also able to bypass the ballast and be plugged directly into the AC 50/60 Hz line voltage should, for example, the ballast fail. Therefore, in addition, to ballast

AC input to DC output power, these embodiments also are able to directly work with 50/60 Hz and have a high power factor (PF) and low total harmonic distortion (THD), are also able to support various types of remote control/dimming, meet FCC EMI conducted and radiated limits, provide over-current (OCP), over-voltage (OVP), over-temperature (OTP) and short circuit protection (SCP).

Implementations of the present invention can be wirelessly dimmed and can support both manual and daylight harvesting controls, including optional standard 0 to 3 V, 0 to 10 V, DALI, DMX, and other interoperable protocols and interfaces including, but not limited to, interfaces that support standards including Building Automation Control Network (BACnet) and can be designed to be interoperable with other building automation system (BAS) vendors, manufacturers, suppliers, etc. in building automation.

The controls allow multiple control systems manufactured by different vendors to work together, sharing information for example but not limited to via a common Web or other-based interface.

As a non-limiting example, implementations of the present invention can use but are not limited to, 2 ft. and 4 ft. T8 and T12 linear fluorescent tube sockets and receive power directly from electronic and also magnetic ballasts (i.e., instant start, rapid start, programmed start) and also from AC 50/60 Hz 80 to 305 VAC, 347 VAC, 480 VAC, etc. It should be noted that these retrofit SSLs and SSL systems do not necessarily need to have the same form factor or footprint as the original light sources (i.e., the LED lights and luminaires can be very different from what they are replacing). Implementations of the present invention can, for example, but not limited to, use wireless (and also, depending on the facility design and intended application and use, wired) signals to both control (e.g., dim) the SSL/LED FLRs and monitor the respective SSL/LED current, voltage and power. For example, a set of low cost, low power sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost/simplicity or Bluetooth, Bluetooth low energy (BLE or BTLE), ZigBee, ZWave, IEEE 802, WiFi, 6LoWPAN, LoRa, etc., combinations of these, etc., and can be secure/encrypted. Occupancy/motion sensors, photo sensors, noise, proximity, ultrasonic, other sound, vision recognition, pattern recognition, voice recognition, other types of recognition(s), etc., other types of sensors and detectors discussed herein, etc., daylight harvesting controls, simple and low cost interfaces that allow existing or other brands, makes, and models of daylight harvesting controls, photo sensors, occupancy/motion sensors to be connected to and control/dim the wireless SSL/LED FLRs and other implementation of the SSL/LED lighting present invention.

Turning to FIG. 38, a wireless controlled solid state lighting system/LED fluorescent lamp replacement 580 with multiple different color temperature lamp types (which is merely one of a more conventional example of innovative and novel SSL/LED lighting) where there are one or more of at least two different color temperature (e.g., cool and warm white) is depicted in accordance with some embodiments of the invention. In this embodiment, for example, two fluorescent lamp replacements 582, 584 have a first color temperature and two other fluorescent lamp replacements 583, 585 have a first color temperature. Of course, the form factor, number of different color temperatures, etc., are merely non-limiting examples. Other embodiments of the present invention can have more than one color temperature and/or color inside of the FLR.

With, for example, a diffuser the effective color can be varied from completely cool white to completely warm white with intermediate color blended combinations of cool and warm white in between. This can be accomplished, for example but not limited to by dimming one or both the different color temperature smart and/or smart enabled FLRs. The simplistic rendering shows alternating cool and warm white lighting where the coloring has been exaggerated for clarity of presentation. Note, other form factors, implementations, etc. including but not limited to having both cool and warm LEDs in the same wireless controlled FLR as well as novel form factors can be employed in implementations of the present invention. As also discussed herein, embodiments and implementations of the present invention can also include one or more SSLs/LEDs with different color temperatures as well as one or more colors or LEDs including but not limited to red, green, blue (RGB), red, green, blue, amber (RGBA), whiteRGBA, multiple color temperatures of whiteRGB and multiple colors of whiteRGB, etc. other colors, wavelengths, etc. of SSLs/LEDs, etc. A capacitor typically in the nanofarad range can be put across the two legs of the ballast through, for example, the tombstones that carry the current to drive the SSL (e.g., LED and/or OLED, QD) fluorescent lamp replacement to effectively reduce the maximum voltage including the open circuit voltage of the ballast.

Some embodiments of the present invention allow for solid state lighting in fixtures with more than one lamp or socket, such as, but not limited to, the embodiment depicted in FIG. 38, allowing for one or more of the fluorescent lamp replacements to be completely turned or dimmed off while permitting one or more of the remaining lamps to be on at dimming levels from zero to one hundred percent. This allows for any combination of color combination tuning and mixing, and color tuning and mixing.

Embodiments of the present invention including but not limited to those depicted in the Figs. can include but are not limited to various implementations of proximity sensors including passive or active or both, IR-based proximity detectors, capacitance-based proximity sensors, other types of proximity sensors, etc., as well as voice commands and can be used to turn on, turn off, dim, flash or change colors including doing so in response to an emergency situation.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wireles sly interactable and/or wireles sly interacting components and/or logically interacting and/or logically interactable components. For example, op amp and comparator in most cases may be used in place of one another in this document.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A lighting system comprising:
at least one solid state light adapted to replace a lamp in a fluorescent lamp fixture; and
a power supply configured to convert power drawn from the fluorescent lamp fixture to power the at least one solid state light, the power supply comprising an auxiliary DC power output, wherein the power supply is configured to generate a regulated DC voltage at the auxiliary DC power output based on the power drawn from the fluorescent lamp fixture.

2. The lighting system of claim 1, the power supply comprising a rectifier, a voltage regulator, and a power output for the at least one solid state light.

3. The lighting system of claim 1, further comprising an isolation circuit configured to control the voltage regulator based on the regulated DC voltage at the auxiliary DC power output.

4. The lighting system of claim 1, further comprising an isolated voltage regulator inductively coupled to the power output for the at least one solid state light to generate an isolated DC voltage based on the power drawn from the fluorescent lamp fixture.

5. The lighting system of claim 4, further comprising an isolation circuit configured to control the voltage regulator based on the isolated DC voltage.

6. The lighting system of claim 4, further comprising a voltage to pulse width converter circuit configured to convert a voltage level-based dimming control signal to a pulse width-based dimming control signal, wherein the voltage to pulse width converter circuit is powered by the isolated DC voltage.

7. The lighting system of claim 1, wherein the power supply is embodied in a fluorescent lamp replacement, and wherein the power supply is configured to automatically draw power from a ballast output in the fluorescent lamp fixture when a ballast is present in the fluorescent lamp fixture.

8. The lighting system of claim 1, wherein the power supply is embodied in a fluorescent lamp replacement, and wherein the power supply is configured to automatically draw power from an AC line in the fluorescent lamp fixture when a ballast is not present in the fluorescent lamp fixture.

9. The lighting system of claim 1, wherein the lighting system comprises a plurality of fluorescent lamp replacements, each comprising at least one of said at least one solid state light and said power supply.

10. The lighting system of claim 9, wherein the lighting system comprises a wall switch configured to control the plurality of fluorescent lamp replacements.

11. The lighting system of claim 10, wherein the wall switch comprises a ballast disengaging circuit.

12. The lighting system of claim 9, wherein the lighting system comprises at least one control system configured to control dimming in the plurality of fluorescent lamp replacements.

13. The lighting system of claim 12, wherein each of the plurality of fluorescent lamp replacements comprise a motion sensor and a signaling transmitter and is configured to activate the signaling transmitter when the motion sensor is trigger, wherein the at least one control system comprises a signaling receiver, wherein the at least one control system is configured to control at least one of the plurality of fluorescent lamp replacements based at least in part on an output of the signaling receiver.

14. The lighting system of claim 12, wherein the lighting system comprises a plurality of interconnected control systems.

15. The lighting system of claim 12, wherein the at least one control system is configured to communicate with at least one remote sensors.

16. The lighting system of claim 12, wherein the at least one control system is configured to communicate with at least one remote sensors using wired and wireless connections.

17. The lighting system of claim 12, wherein the at least one control system is configured to communicate with a gateway device.

18. The lighting system of claim 12, wherein the at least one control system is configured to communicate with remote devices through a gateway device.

19. The lighting system of claim 1, further comprising an inrush current resistive element and bypass switch.

20. The lighting system of claim 1, further comprising a heater emulation circuit.
